(19) United States
(12) Patent Application Publication
(10) Pub. No.: US 2023/0282412 A1
(43) Pub. Date: Sep. 7, 2023

(54) POWER GENERATING TRANSFORMER SYSTEM (PGTS), A POWER FACTOR CORRECTION METHOD IN PGTS, A PGTS FUNCTIONING ALSO AS POWER SUPPLY, AND BLOCK DIAGRAMS OF PGTS

(71) Applicant: PHASETOWN, LLC, Daejeon (KR)

(72) Inventors: Won Don LEE, Daejeon (KR); Hijung CHAI, Daejeon (KR)

(73) Assignee: PHASETOWN, LLC, Daejeon (KR)

(21) Appl. No.: 17/768,857

(22) PCT Filed: Feb. 10, 2020
(86) PCT No.: PCT/KR2020/001823

§ 371 Date: Apr. 14, 2022

(30) Foreign Application Priority Data
Oct. 16, 2019 (KR) 10-2019-0128729

(51) Int. Cl. H01F 27/34; H02J 3/16; H02M 1/42

(52) U.S. Cl. CPC H01F 27/341; H02J 3/16; H02M 1/42; H01F 3/00

(57) ABSTRACT

A power generating transformer system (PGTS) where the core of the transformer has one of the generalized configurations is presented. Also, a power factor correction method in a power generating transformer system (PGTS) and a PGTS functioning also as power supply are presented. A PGTS generates an AC voltage with the frequency which lets the desired relative phase which is the difference between the phase of the flux at the primary coil and that of the flux at the secondary coil be in a specified range. And by controlling the reactive power at the primary coil of the transformer of the transformer circuit or at the location where the AC voltage is generated, the power factor correction is done using one or more components in the transformer circuit (TC). Finally, block diagrams of PGTS are presented.

### TECHNICAL FIELD

One or more embodiments related to a method and apparatus for a PGTS, power factor correction in PGTS, PGTS functioning as power supply, and block diagrams of PGTS.

### BACKGROUND ART

A Transformer is a device that changes a value of a voltage into a desired value by using a primary coil and a secondary coil. When current flows through a coil connected to a power source, a magnetic field is formed in a core. As the current from the power source changes over time, the magnitude of the magnetic field also changes. The magnetic field is delivered through the core to induce an electromotive force into the secondary coil with electromagnetic induction, and current is generated by the induced electromotive force. That is, when alternating current (AC) power is supplied to the primary coil, an AC current is also induced at the secondary coil.

### DISCLOSURE

### Technical Problem

One or more embodiments include a method, whereby the shape of a magnetic core of a transformer in a power generating transformer system (PGTS) is generalized and a power factor is corrected by minimizing the magnitude of reactive power at the primary circuit or at a location where AC is generated, and a PGTS functioning also as a power supply, and block diagrams of PGTS.

### Technical Solution

According to one or more embodiments, a power generating transformer system (PGTS) includes a transformer circuit (TC) including a transformer, a “rectifier and filter” module, and a load, an alternating current (AC) generator with right frequency (ACRF) configured to generate AC with frequency which lets a desired relative phase that is a difference between a phase of a flux at a primary coil and that of a flux at a secondary coil of the transformer of the TC be in a specified range.

According to one or more embodiments, a method of correcting a power factor in a power generating transformer system (PGTS) includes generating alternating current (AC) with frequency which lets a desired relative phase that is a difference between a phase of a flux at a primary coil and that of a flux at a secondary coil of a transformer of the TC be in a specified range and correcting a power factor by controlling reactive power at the primary coil of the transformer of the TC or at a location where the AC is generated, by using one or more components in the TC.

### Advantageous Effects

### A. Configuration of the Magnetic Core of the Transformer

The principles of this invention can be applied to any kind of transformer whose magnetic core which is non-air has a closed loop or an open loop configuration and whose primary coil and secondary coil are wound at certain locations of the core, by calculating the dependency of impedance and power on the relative phase.

### B. Power Factor Correction in the Power Generating Transformer System (PGTS)

In the “power generating transformer system (PGTS)” described in the PCT international patent application #PCT/KR2017/014540, the “AC generator with right frequency (ACRF)” module provides the necessary AC (alternative voltage) signal to the transformer circuit (to differentiate from the general transformer circuit, this is notated as TC). The impedance of the TC is adjusted by controlling the amount of the phase change of the flux when the flux propagates through the core.

The phase of the impedance of the TC, which is the difference between the phase of the voltage and that of the current at the primary circuit of the transformer of the TC, can be adjusted so that the real power sent from the ACRF to the primary circuit of the transformer can be (close to) zero or even negative. We omit the unit of power or other physical quantities for convenience.

The reason why the magnitude of the real power sent from the ACRF becomes a small quantity is not because the amplitude of the current is small, but because of the difference between the phase of the voltage and that of the current.

In an alternating current circuit, the real power is an integral of the multiplication of the voltage and the current waves averaged over a complete cycle. If the impedance lies in the first or the fourth quadrant of the impedance complex plane, the integral value always becomes positive, resulting in power consumption.

If, however, there is a way to put the impedance in the second or the third quadrant of the complex plane, then the integral value becomes negative, and power is generated. The document of the PCT international patent application #PCT/KR2017/014540 deals with the problem of how to put the impedance in any quadrant by adjusting the phase change of the flux which propagates through the core in a transformer circuit.

Although the magnitude of the real power sent from the ACRF becomes a small quantity, the magnitude of the apparent power still can be large and the ACRF needs to generate the current with a large amplitude. Therefore, the ACRF becomes unnecessarily inefficient. That is why we need a power factor correction in the power generating transformer system (PGTS). When the power factor corrector is added, the ACRF does not have to generate a current with a large amplitude and becomes efficient.

The power factor correction suggested in the example illustrated in this invention is different from the traditional power factor correction as follows:
1. The power factor correction in the example illustrated in this invention is not to minimize the magnitude of the reactive power at the load in the secondary circuit of the transformer of the TC, but to minimize the magnitude of the reactive power at the primary coil of the transformer of the TC or at the location where AC is generated. In contrast, the traditional theory on the transformer circuit does not take into account of the phase change that the flux undergoes when it propagates through the core, and thus assumes that the power supplied to the primary coil of the transformer is the same as the power dissipated at the load in the secondary circuit without any change in the phase. Therefore, the traditional power factor correction in a transformer circuit is to minimize the magnitude of the reactive power at the load in the secondary circuit of the transformer, which is regarded the same as the reactive power sent from the power supply.
2. When the impedance of the TC is placed at the second or the third quadrant, then the power factor correction of this invention makes the power factor to be (close to) (−1) by minimizing the magnitude of the reactive power. In contrast, the traditional power factor correction is to make the power factor to be (close to) 1 by minimizing the magnitude of the reactive power.

### C. Speed of the Flux in the Magnetic Core of the PGTS

As the speed of the flux in the magnetic core is slower, the phase change that the flux undergoes in the magnetic core gets bigger. Also, the speed of the flux depends on the permeability, the permittivity, and the loss tangents of the material. Therefore, by using a material having slower speed of the flux in the magnetic core, the phase change of the flux can be controlled more easily and the desired phase change can be achieved with a wave of a lower frequency or with a shorter magnetic core when other conditions remain the same.

### D. Power Generating Wireless Power Transmission System

Also, when the core is air or consists of a material and air, the PGTS becomes a power generating system as well as a wireless power transmission system. A system can be made that transfers power wirelessly without consuming any power or even while generating power at the transmitter. The principles in the example illustrated in this invention can be applied not only when the core is a material, but also when the core is air or consists of air and any other material(s).

### E. Converting a Machine Using a Transformer to a PGTS

Machines using a transformer can be converted to a PGTS. The principles on how to modify a machine using a transformer to a PGTS are explained using a switched mode power supply (SMPS) as an example. Also, in the modified machines, the same principle of the power factor correction discussed in this invention can be applied.

### F. PGTS as a Power Supply

In the example illustrated in this invention, it is shown that a PGTS can be a power supply that makes more power dissipated at the load while supplying less power.

### G. Power Factor Correction in a PGTS as a Power Supply

When a PGTS is used as a power supply, the same principle for the power factor correction can be applied.

H. Modifying a Machine with a Transformer to a PGTS as a Power Supply

A machine using a transformer can be converted to a power supply which consumes less power.

I. Block Diagrams of PGTS without Feedback

PGTSs can be classified into two categories: the one without a feedback loop and the one with a feedback loop. Block diagrams of PGTS without feedback are presented.

J. Block Diagrams of PGTS with Feedback

Block diagrams of PGTS with feedback are presented.

### K. Simplified Block Diagrams of PGTS

Simplified block diagrams of PGTS are presented.

### DESCRIPTION OF DRAWINGS

FIG. 1 shows a single phase transformer circuit.

FIG. 2 shows an example of a transformer where the magnetic core made of a material has a closed loop configuration.

FIG. 3 shows an example of a transformer where the magnetic core made of a material has an open loop configuration.

FIG. 4 shows values of the denominator of K represented as a circle with the radius of |Γ|exp(− [symbol] ).

FIG. 5 shows a power triangle and an illustration of the power factor correction.

FIG. 6 shows a power generating transformer system (PGTS).

FIG. 7 shows a power triangle in the case when the power factor is negative.

FIG. 8 shows an example of a PGTS including a power factor corrector.

FIG. 9 shows equivalent circuits of power generating transformer systems (PGTSs).

FIG. 10 shows a switched mode power supply with a transformer.

FIG. 11 shows a switch part of an ACRF of a PGTS in the form of H-bridge.

FIG. 12 shows a block diagram of a power generating transformer system (PGTS).

FIG. 13 shows a block diagram of a PGTS without feedback.

FIG. 14 shows an example of a block diagram of a PGTS without feedback with a half-bridge or a full-bridge as the amplifier and with an SMPS as the DC-to-DC converter.

FIG. 15 shows a full-bridge connected to a TRAN.

FIG. 16 shows a block diagram of a PGTS with feedback.

FIG. 17 shows an example of a block diagram of a PGTS with feedback with a half-bridge or a full-bridge as the amplifier and with an SMPS as the DC-to-DC converter.

FIG. 18 shows a block diagram of an SMPS with a transformer.

FIG. 19 shows a block diagram of a control unit of an SMPS using a pulse-width modulation (PWM).

FIG. 20 shows a simplified block diagram of a PGTS without feedback.

FIG. 21 shows a simplified block diagram of a PGTS without feedback that uses a half-bridge or a full-bridge amplifier.

FIG. 22 shows a simplified block diagram of a PGTS with feedback.

FIG. 23 shows a simplified block diagram of a PGTS with feedback with a voltage converter.

FIG. 24 shows a simplified block diagram of a PGTS with feedback with a half-bridge or a full-bridge amplifier.

### MODE FOR INVENTION

First of all, we review the equations for a transformer circuit and for powers described in the PCT international patent application #PCT/KR2017/014540.

### A. New Equations for a Transformer Circuit

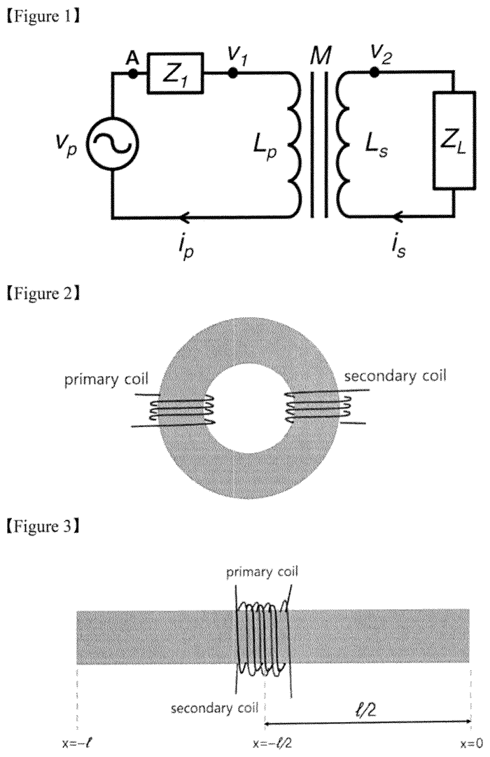

FIG. 1 shows a single phase transformer circuit.

Let us consider a single phase transformer circuit as in FIG. 1, where vₚ is the AC sinusoidal input voltage with the angular frequency ω; v₁ and v₂ are the voltages at the primary and the secondary coils, respectively; Zₗ is the impedance in series with the voltage source in the primary circuit, which can include the impedance of the circuits such as filters and other necessary circuits before the primary circuit of the transformer and the impedance of the load at the primary side; and Z_{L} is the impedance of the load at the secondary circuit; iₚ and iₛ are the currents of the primary and the secondary circuits, respectively; Lₚ and Lₛ are the self-inductances of the primary and the secondary coils, respectively; Nₚ and Nₛ are the numbers of turns of the primary and the secondary coils, respectively; n is the turns ratio which is equal to Nₛ/Nₚ; and M is the mutual inductance.

Then, the traditional equations for the transformer circuit are as follows: (B. I. Bleaney, B. Bleaney, Alternating Current Theory, In Electricity and Magnetism, 2nd ed., Oxford Univ. Press: London, England, 1965, p. 248.)

v₁=Lₚ(diₚ/dt)−M(diₛ/dt)=jωLₚiₚ−jωMiₛ, (1)

0=(Z_{L}+jωLₛ)iₛ−jωMiₚ. (2)

The impedance Zₚ of the circuit, vₗ/iₚ, excluding the impedance Zₗ which is in series with the voltage source in the primary circuit, can be derived from the equations above:

Zₚ=vₗ/iₚ=jωLₚ+ω²M²/(Z_{L}+jωLₛ). (3)

Recently, there was a report on a new set of equations for a transformer circuit which considers the attenuation and the phase change of the flux that occur as it propagates through the core. (PCT International application #: PCT/KR2017/014540)

A current i in a coil generates a flux Φ according to the following relation:

Ni=Φ [symbol] , (4)

where N, i, Φ, and [symbol] are the number of turns of the coil, the current, the flux, and the reluctance, respectively. As the flux is in phase with the current wave, it is described as a wave showing the flux quantity at the cross section along the core.

The current iₚ of the primary circuit generates the flux Φ_{f}(p) going in the forward direction from the primary coil to the secondary coil according to the relation above, where the subscript f signifies that the flux is traveling in the “forward” direction from the primary coil to the secondary coil, and the letter p signifies that the location of the flux is at the “primary” coil:

Φ_{f}(p)=Nₚiₚ/ [symbol] . (5)

The voltage v_{f}(p) at the primary coil due to the flux is related to the current iₚ at the primary coil as follows:

v_{f}(p)=NₚdΦ_{f}(p)/dt=(Nₚ²/ [symbol] )diₚ/dt=Lₚdiₚ/dt=jωLₚiₚ. (6)

To describe the attenuation and the phase change of the flux as it propagates through the core, the propagation constant γ is introduced, just as in the transmission line model:

γ=α+jβ, (7)

where α and β are the attenuation constant and the phase constant, respectively.

The attenuation of the flux can be expressed as exp(−α [symbol] ), where [symbol] is the length of the magnetic core when the flux travels from the primary coil to the secondary coil. The phase change of the flux is (−ϕ) for a distance of [symbol] , where ϕ is called the “relative phase” and is related to β in the following manner:

ϕ=β [symbol] =ω [symbol] /υv=2πf [symbol] /υ, (8)

where υ is the propagation speed of the flux in the magnetic core in the ideal case and f is the frequency.

Let us consider Equation (2) which describes the secondary circuit of the transformer. The right hand side has two terms. The first term, (Z_{L}+jωLₛ)iₛ, contains the current iₛ in the secondary circuit, the self-inductance Lₛ of the secondary coil, and the impedance Z_{L} of the load. Because the current iₛ is the one that flows in the secondary circuit, the first term describes the voltage drop due to the current and the impedance in the secondary circuit.

The second term, (−jωMiₚ), however, describes the voltage due to the mutual induction related to the primary current iₚ. The flux Φ_{f}(p) at the primary coil generated by the primary current iₚ should be propagated through the core to the secondary coil to affect the generation of the voltage at the secondary coil. When the flux Φ_{f}(p) propagates, attenuation and phase change occur, and therefore, the flux Φ_{f}(s) that is propagated to the secondary coil is described as follows, where the letter s signifies the location at the “secondary” coil:

Φ_{f}(s)=exp(− [symbol] )Φ_{f}(p)=exp(− [symbol] )exp(−jϕ)Φ_{f}(p). (9)

Then, the flux Φ_{f}(s) induces the voltage v_{f}(s) at the secondary coil through the mutual induction:

v_{f}(s)=Nₛd[Φ_{f}(s)]/dt=Nₛd[exp(− [symbol] )Φ_{f}(p)]/dt

=Nₛd[exp(− [symbol] )Nₚiₚ/ [symbol] ]/dt=(NₛNₚ/ [symbol] )d[exp(− [symbol] )iₚ]/dt

=M exp(− [symbol] )(diₚ/dt)=jωM exp(− [symbol] )iₚ. (10)

The current iₛ in the secondary circuit is determined by the impedance of the secondary circuit and the voltage v_{f}(s) as follows:

iₛ=v_{f}(s)/(jωLₛ+Z_{L})=jωM exp(− [symbol] )iₚ/(jωLₛ+Z_{L})=exp(− [symbol] )Γ_{L}iₚ, (11)

where Γ_{L} is defined as

Γ_{L}=jωM/(jωLₛ+Z_{L}). (12)

Note that Equation (10) shows that the voltage v_{f}(s) at the secondary coil is related to the current exp(− [symbol] )iₚ through the mutual induction. The expression exp(− [symbol] )iₚ represents the attenuation and the phase change that the primary current iₚ has just as the flux undergoes, and can be regarded as the expression of how primary current affects the generation of the voltage v_{f}(s) at the secondary coil, although there is no actual current traveling through the magnetic core. Γ_{L}, represents the ratio of the current iₛ in the secondary circuit to the primary current exp(− [symbol] )iₚ that has undergone the attenuation and the phase change.

Although there is no current flow at the core, since the primary current iₚ and the flux Φ_{f}(p) traveling in the forward direction from the primary coil are related to each other by Equation (4), the primary current iₚ is regarded to undergo as much attenuation and phase change as the flux undergoes when iₚ is applied in the equation of the secondary circuit.

Then, according to Equation (11), the equation describing the secondary circuit should be as follows:

0=(Z_{L}+jωLₛ)iₛ−jωM exp(− [symbol] )iₚ. (13)

Note that the equation above is different from the traditional Equation (2). Instead of the primary current iₚ as in Equation (2), the equation above utilizes exp(− [symbol] )iₚ, the primary current that has undergone attenuation and phase change.

Now, consider Equation (1) which describes the primary circuit of the transformer. The voltage v₁ at the primary coil is a sum of the two voltages: the voltage from the self-inductance, jωLₚiₚ, and the one from the mutual inductance, (−jωMiₛ).

The voltage from the self-inductance is related to the current iₚ in the primary circuit, without having to do with the secondary circuit. Therefore, the current iₚ associated with the voltage jωLₚiₚ from the self-inductance does not undergo any change in magnitude or in phase due to the propagation of the flux through the magnetic core.

The voltage expression (−jωMiₛ) from the mutual inductance, however, contains the current iₛ, which is the current of the secondary circuit. Although there is no direct current flow in the core, the current iₛ that runs through the secondary circuit causes the flux Φ_{b}(s) to be generated at the secondary coil in the opposite direction as follows. Here, the subscript b refers to the “backward” direction from the secondary coil to the primary coil:

Φ_{b}(s)=−(Nₛ/ [symbol] )iₛ=−−(Nₛ/ [symbol] )exp(− [symbol] )Γ_{L}iₚ

=⁻(Nₛ/ [symbol] )exp(− [symbol] )Γ_{L}Φ_{f}(p) [symbol] /Nₚ

=−(Nₛ/Nₚ)Γ_{L}Φ_{f}(s)=−nΓ_{L}Φ_{f}(s). (14)

From the equation above, the ratio of the flux Φ_{b}(s) reflected at the secondary coil to the flux Φ_{f}(s) arriving at the secondary coil is (−nΓ_{L}).

This flux Φ_{b}(s) propagates back to the primary coil to become the flux Φ_{b}(p) at the primary coil. When the backward flux Φ_{b}(s) propagates from the secondary to the primary coil through the magnetic core, it also undergoes the same amounts of attenuation and phase change that the flux in the forward direction underwent.

Φ_{b}(p)=exp(− [symbol] )Φ_{b}(s)=exp(− [symbol] )exp(−jϕ)Φ_{b}(s). (15)

The flux Φ_{b}(p) induces the voltage v_{b}(p) at the primary coil:

v_{b}(p)=Nₚd[Φ_{b}(p)]/dt=Nₚd[exp(− [symbol] )Φ_{b}(s)]/dt

=Nₚ exp(− [symbol] )d[−(Nₛ/ [symbol] )iₛ]/dt

=−(NₚNₛ/ [symbol] )exp(− [symbol] )diₛ/dt=−jωM exp(− [symbol] )iₛ. (16)

The voltage at the primary coil, vₗ, has the following relation:

vₗ=vₚ−iₚZₗ=v_{f}(p)+v_{b}(p)

=jωLₚiₚ−jωM exp(− [symbol] )iₛ=jωLₚiₚ−jωM exp(−2 [symbol] )Γ_{L}iₚ

=jωLₚiₚ+ω²M² exp(−2 [symbol] )iₚ/(jωLₛ+Z_{L}). (17)

Unlike in Equation (1) which is a traditional expression for the voltage at the primary coil, the induced voltage v_{b}(p) in the equation above is [−jωM exp(− [symbol] )iₛ], whereas it is (jωMiₛ) in Equation (1).

Therefore, the current iₛ in Equation (1) should be modified to encompass the attenuation and the phase change of the backward flux, and it becomes exp(− [symbol] )iₛ:

exp(− [symbol] )iₛ=exp(− [symbol] )exp(−jϕ)iₛ. (18)

In other words, the attenuation and the phase change that the flux undergoes are reflected in the newly derived equations, while they are not in the traditional equations of the transformer circuit. The secondary current iₛ cannot instantly induce the voltage at the primary coil; the flux from the secondary coil needs to come to the primary coil to induce the voltage at the primary coil. The factor exp(− [symbol] ) effectively describes the change that takes place during the flux propagation.

Equation (17) can be rewritten to find the primary current iₚ as follows:

iₚ(jωLₚ+Zₗ)=vₚ+jωM exp(− [symbol] )iₛ, (19)

iₚ=vₚ/(jωLₚ+Zₗ)+jωM exp(− [symbol] )iₛ/(jωLₚ+Zₗ) (20)

The above equation shows that the primary current is a sum of two parts: the first term is the source voltage vₚ divided by the impedance of the primary circuit, and the second is the one related to the secondary current iₛ.

From Equation (17), the impedance Zₚ of the circuit excluding the impedance Zₗ becomes:

Zₚ=vₗ/iₚ=jωLₚ+exp(−2 [symbol] )ω²M²/(jωLₛ+Z_{L})

=jωLₚ+exp(−2 [symbol] )exp(j2ϕ)ω²M²/(jωLₛ+Z_{L}). (21)

Note that the expression above is different from the traditional Equation (3) as it has the factor exp(−2 [symbol] ) in the second term. The impedance Zₚ depends on the relative phase ϕ. Thus, the impedance can be adjusted by controlling the relative phase. If there is a way to set the relative phase ϕ to a desired value, then according to the second term in the equation above, the phase of the impedance of the transformer circuit is set by the relative phase ϕ. And the circuit impedance Zₚ can be adjusted accordingly.

An interesting case is when the phase of the impedance of the transformer circuit is adjusted to make the power factor be zero. In other words, the real power the source sends to the primary coil becomes effectively zero. This case of zero power factor is possible because the flux coming from the secondary coil delivers the information of the changed phase of the load in the secondary circuit to the primary coil as if the secondary circuit has only the reactive components. Of course, the secondary circuit might have some real resistive load, but as the phase is changed while the flux propagates, the primary coil is “deceived” by “seeing” the changed phase.

Therefore, although the source sends power with the power factor of zero to the primary coil, when the secondary coil receives the flux which underwent the phase change while coming from the primary coil, it can generate the necessary emf and the current according to the impedance of the secondary circuit.

Of course, the impedance Z_{C} of the circuit, including the impedance Zₗ, becomes:

Z_{C}=vₚ/iₚ=Zₗ+jωLₚ+exp(−2 [symbol] )ω²M²/(jωLₛ+Z_{L}). (22)

Impedance Z_{C} is found by adding the impedance Zₗ in series with the voltage source to the impedance Zₚ at the primary coil of the transformer. From now on, when we explain the principles of the invention, we will use the impedance at the primary coil of the transformer as an example. But the same principle can be applied to the impedance including the primary impedance Zₗ in the primary circuit.

### B. Powers

The real power Pₚ at the primary coil is:

$$\begin{matrix}{P}_{p} = ( 1 / 2 ) Re ( {v}_{1} {i}_{p}^{*} ) = ( 1 / 2 ) Re \{ [ j ω {L}_{p} {i}_{p} - j ω M exp ( - γ ℓ ) {i}_{s} ] {i}_{p}^{*} \} \\ = ( 1 / 2 ) Re \{ [ j ω {L}_{p} {i}_{p} - j ω M exp ( - 2 γℓ ) {Γ}_{L} {i}_{p} ] {i}_{p}^{*} \} = \\ ( 1 / 2 ) {\vert {i}_{p} \vert}^{2} Re [ j ω {L}_{p} - j ω M exp ( - 2 γ ℓ ) {Γ}_{L} ] \\ = ( 1 / 2 ) exp ( - 2 α ℓ ) {\vert {i}_{p} \vert}^{2} Re \{ - j ω M exp [ j ( {θ}_{Γ} - 2 ϕ ) ] \vert {Γ}_{L} \vert \} \\ = ( 1 / 2 ) exp ( - 2 αℓ ) ω M {\vert {i}_{p} \vert}^{2} \vert {Γ}_{L} \vert Re \{ - j exp [ j ( {θ}_{Γ} - 2 ϕ ) ] \} \\ = ( 1 / 2 ) exp ( - 2 αℓ ) ω M {\vert {i}_{p} \vert}^{2} \vert {Γ}_{L} \vert sin ( {θ}_{Γ} 2 ϕ ) ,\end{matrix} \qquad ( 23 )$$

where θ_{Γ} is the phase of Γ_{L}.

From Equation (13), the voltage v₂ at the secondary coil is:

v₂=Z_{L}iₛ=jωM exp(− [symbol] )iₚ−jωLₛiₛ (24)

The real power P_{L} at the load is:

$$\begin{matrix}{P}_{L} = ( 1 / 2 ) Re ( {v}_{2} {i}_{s}^{*} ) = ( 1 / 2 ) Re [ ( {Z}_{L} {i}_{s} ) {i}_{s}^{*} ] \\ = ( 1 / 2 ) Re \{ [ j ω M exp ( - γℓ ) {i}_{p} - \\ {j ω {L}_{s} exp ( - γℓ ) {Γ}_{L} {i}_{p} ] [ exp ( - γℓ ) {Γ}_{L} {i}_{p} ]}^{*} \} \\ {= ( 1 / 2 ) exp ( - 2 αℓ ) ω {\vert {i}_{p} \vert}^{2} Re [ jM {Γ}_{L}^{*} - {jL}_{s} \vert {Γ}_{L} \vert}^{2} ] \\ = ( 1 / 2 ) exp ( - 2 αℓ ) ω M {\vert {i}_{p} \vert}^{2} \vert {Γ}_{L} \vert sin {θ}_{Γ} .\end{matrix} \qquad ( 25 )$$

Note that the real power at the primary coil is dependent on the relative phase ϕ, while the real power at the load is not.

The power difference (P_{L}−Pₚ) between the power at the load and that at the primary coil becomes:

P_{L}−Pₚ=(½)exp(−2 [symbol] )ωM|iₚ|²|Γ_{L}|sin θ_{Γ}−(½)exp(−2 [symbol] )ωM|iₚ|²|Γ_{L}|sin(θ_{Γ}−2ϕ)=(½)exp(−2 [symbol] )ωM|iₚ|²|Γ_{L}|[sin θ_{Γ}−sin(θ_{Γ}−2ϕ)]. (26)

The power difference becomes positive if the following condition is met:

sin θ_{Γ}−sin(θ_{Γ}−2ϕ)=2 cos(θ_{Γ}−ϕ)sin ϕ>0. (27)

In other words, the real power dissipated at the load becomes larger than the one at the primary coil if the condition above is satisfied.

Note that the power Pₚ does not include power losses, such as core losses and Joule losses, etc. The power Pₚ at the primary coil is the counterpart of the power dissipated at the load. Therefore, the real power Pₘ supplied by the ACRF when measured at the primary coil is larger than the power Pₚ by the amount of power loss Pₗ:

Pₘ=Pₚ+Pₗ. (28)

Therefore, in a real application, the power difference between the power at the load and that at the primary coil is expressed as (P_{L}−Pₘ).

Next, we describe in detail the PGTSs having magnetic cores with various configurations, the power factor correction method in a PGTS, a PGTS functioning also as power supply, and block diagrams of PGTS in the example illustrated in this invention.

### A. Configurations of the Magnetic Core of the Transformer

FIG. 2 shows an example of a transformer where the magnetic core made of a material has a closed loop configuration.

So far, the equations are derived for the circuit where the magnetic core of the transformer has a closed loop configuration as in FIG. 2. But we need to consider the case when the air becomes part of the core and the magnetic core made of a material has an open loop configuration. In fact, as the core includes the air, although the magnetic core made of a material is an open loop configuration, the whole path of the flux is a closed loop. But, for the sake of convenience, we need to differentiate whether a magnetic core made of a material which is not air has an open loop or a closed loop configuration.

Also, air here refers to not only just air but also any medium which the flux propagates through and is not a magnetic core. For instance, if the PGTS is in the astronomical space, then this “air” refers to the vacuum.

FIG. 3 shows an example of a transformer where the magnetic core made of a material has an open loop configuration.

Let there be a bar type core with length of [symbol] as shown in FIG. 3. Let the position at the core be represented by x-coordinate and the position at the right end be (x=0). Then the center of the bar is apart from the right end by the distance of [symbol] /2 at (x=− [symbol] /2). And let, as an example, the primary and the secondary coils be wound at the center of the bar.

First, the flux Φ_{f}(− [symbol] /2) going from the primary coil to the secondary coil is generated by the primary current iₚ:

Φ_{f}(− [symbol] /2)=Nₚiₚ/ [symbol] . (29)

In that case, because the secondary coil is positioned at the same place where the primary coil is, the flux Φ_{f}(− [symbol] /2) generated at the primary coil goes immediately to the secondary coil. But, we will not describe the event according to the chronological sequence as it is more convenient to add up the waves reflected at the right and the left ends together and then send the combined wave to the secondary coil.

Now, the flux generated at the primary coil goes to the right end through the magnetic core. As the flux propagates by the distance of [symbol] /2, it undergoes the attenuation and the phase change and the flux Φᵣₗ(0) at (x=0) becomes as follows.

Φᵣₗ(0)=exp(− [symbol] /2)Φ_{f}(− [symbol] /2)=exp(− [symbol] /2)exp(−jϕ/2)Φ_{f}(− [symbol] /2). (30)

From there, the flux Φᵣₗ(0) is reflected and becomes Φₗₗ(0) and propagates back in the left direction:

Φₗₗ(0)=ΓΦᵣₗ(0)=Γ exp(− [symbol] /2)Φ_{f}(− [symbol] /2), (31)

where Γ is the reflection coefficient which is related to the intrinsic impedances of the material of the magnetic core and air. (B. I. Bleaney, B. Bleaney, Alternating Current Theory, In Electricity and Magnetism, 2nd ed.; Oxford Univ. Press: London, England, 1965; p 241.) At the end of the material core, not only a reflection but also a transmission occurs, but we assume that the amount of the transmission is negligible.

The reflected flux Φₗₗ(0) comes to the center at (x=− [symbol] 2) and becomes the flux Φₗₗ(− [symbol] /2) as follows:

Φₗₗ(− [symbol] /2)=exp(− [symbol] /2)Φₗₗ(0)=Γ exp(− [symbol] /2)Φᵣₗ(0)=Γ exp(− [symbol] )Φ_{f}(− [symbol] /2). (32)

And it goes to the left end at (x=− [symbol] ) and becomes as follows:

Φₗₗ(− [symbol] )=exp(− [symbol] /2)Φₗₗ(− [symbol] /2)=Γ exp(− [symbol] /2)Φⱼ(− [symbol] /2). (33)

At the left end at (x=− [symbol] ), it is reflected again and becomes the flux Φᵣ₂(− [symbol] ) going in the right direction:

Φᵣ₂(− [symbol] )=ΓΦ₁₁(− [symbol] )=Γ²exp(−3 [symbol] /2)Φ_{f}(− [symbol] /2). (34)

It comes to the center and becomes as follows:

Φᵣ₂(− [symbol] /2)=exp(− [symbol] /2)Φᵣ₂(− [symbol] )=Γ² exp(−2 [symbol] )Φ_{f}(− [symbol] /2). (35)

As there are infinite reflections at the right end and at the left end, the flux Φ(− [symbol] /2) of the primary coil at the center is described as follows:

Φ(− [symbol] /2)=Σᵢ₌₀^{∞}(Γⁱ exp(−i [symbol] )Φ_{f}(− [symbol] /2))=Φ_{f}(− [symbol] /2)/[1−Γ exp(− [symbol] /2)]=KΦ_{f}(− [symbol] /2), (36)

where K is related to the reflection coefficient Γ, the length [symbol] of the material core, the attenuation constant α, and the relative phase ϕ as follows:

K=|K|exp(jθ_{K})=1/[1−Γ exp(− [symbol] )], (37)

where θ_{K} is the phase of K.

The flux Φ(− [symbol] /2) is the flux Φ_{f}(p) which goes from the primary coil to the secondary coil:

Φ_{f}(p)=Φ(− [symbol] /2). (38)

The voltage v_{f}(p) at the primary coil by the flux Φ_{f}(p) is determined as follows:

$$\begin{matrix}{v}_{f} ( p ) = {N}_{p} d {Φ}_{f} ( p ) / dt = {N}_{p} d [ K {Φ}_{f} ( - ℓ / 2 ) ] / dt \\ = {KN}_{p} d {Φ}_{f} ( - ℓ / 2 ) / dt \\ = {KN}_{p} d ( {N}_{p} {i}_{p} / ) / dt \\ = ( {KN}_{p}^{2} / ) {di}_{p} / dt = jK ω {L}_{p} {i}_{p} .\end{matrix} \qquad ( 39 )$$

In this case, since the secondary coil is wound where the primary coil is located, flux Φ_{f}(p) reaches the secondary coil without significant attenuation or phase change to become the flux Φ_{f}(s):

Φ_{f}(s)=Φ_{f}(p)=KΦ_{f}(− [symbol] /2). (40)

The flux Φ_{f}(s) generates the voltage v_{f}(s) at the secondary coil through the mutual inductance:

$$\begin{matrix}{v}_{f} ( s ) = {N}_{s} d [ {Φ}_{f} ( s ) ] / dt = {N}_{s} d [ K {Φ}_{f} ( - ℓ / 2 ) ] / dt \\ = {KN}_{s} d [ {N}_{p} {i}_{p} / ] / dt = ( {KN}_{s} {N}_{p} / ) {di}_{p} / dt \\ = {KMdi}_{p} / dt = jK ω {Mi}_{p} .\end{matrix} \qquad ( 41 )$$

If there were no reflections of the flux, the voltage v_{f}(s) at the secondary coil induced by Φ_{f}(s) would be just jωMiₚ, but because the flux is reflected infinite times at both ends with the reflection coefficient of Γ, the factor K is introduced in the equation above.

The current iₛ in the secondary circuit becomes:

iₛ=v_{f}(s)/(jωLₛ+Z_{L})=jKωMiₚ/(jωLₛ+Z_{L})=KΓ_{L}_{ⁱ}ₚ, (42)

where Γ_{L} is already defined earlier.

At the center where secondary coil is, the backward flux Φ_{b}(− [symbol] /2) is formed:

Φ_{b}(− [symbol] /2)=−(Nₛ/ [symbol] )iₛ=−(Nₛ/ [symbol] )KΓ_{L}_{ⁱ}ₚ

=−(Nₛ/ [symbol] )KΓ_{L}Φ_{f}(− [symbol] /2)( [symbol] /Nₚ)=−nKΓ_{L}Φ_{f}(− [symbol] /2). (43)

As this flux heads toward the primary coil, it joins all the reflected waves to form the flux Φ_{b}(s) at the secondary coil as the flux Φ_{f}(− [symbol] /2) underwent, which then becomes the flux Φ_{b}(p) at the primary coil without significant attenuation or phase change:

$$\begin{matrix}{Φ}_{b} ( p ) = {Φ}_{b} ( s ) = {Φ}_{b} ( - ℓ / 2 ) / [ 1 - Γ exp ( - γℓ ) ] \\ = - nK {Γ}_{L} {Φ}_{f} ( - ℓ / 2 ) / [ 1 - Γ exp ( - γℓ ) ] \\ = - {nK}^{2} {Γ}_{L} {Φ}_{f} ( - ℓ / 2 ) .\end{matrix} \qquad ( 44 )$$

Flux Φ_{b}(p) induces the voltage v_{b}(p) at the primary coil:

$$\begin{matrix}{v}_{b} ( p ) = {N}_{p} d [ {Φ}_{b} ( p ) ] / dt = - {nN}_{p} {K}^{2} {Γ}_{L} d [ {Φ}_{f} ( - ℓ / 2 ) ] / dt \\ = - {nN}_{p} {K}^{2} {Γ}_{L} d ( {N}_{p} {i}_{p} / ) / dt \\ = - ( {nN}_{p}^{2} / ) {K}^{2} {Γ}_{L} {di}_{p} / dt = - j ω {nL}_{p} {K}^{2} {Γ}_{L} {i}_{p} \\ = - j ω {MK}^{2} {Γ}_{L} {i}_{p} .\end{matrix} \qquad ( 45 )$$

The voltage v₁ at the primary coil becomes as follows:

vₗ=vₚ−iₚZₗ=v_{f}(p)+v_{b}(p)

=jKωLₚiₚ−jωMK²Γ_{L}_{ⁱ}ₚ. (46)

The impedance of the circuit excluding the impedance Zₗ becomes:

Zₚ=vₗ/iₚ=jKωLₚ−jωMK²Γ_{L}

=(jωLₚ+ω²M²/{[1−Γ exp(− [symbol] )](jωLₛ+Z_{L})})/[1−Γ exp(− [symbol] )]. (47)

The impedance Zₚ is dependent on the relative phase ϕ in this case also.

The power Pₚ at the primary coil is:

$$\begin{matrix}{P}_{p} = ( 1 / 2 ) Re ( {v}_{1} {i}_{p}^{*} ) \\ = ( 1 / 2 ) Re [ ( jK ω {L}_{p} {i}_{p} - j ω {MK}^{2} {Γ}_{L} {i}_{p} ) {i}_{p}^{*} ] \\ = ( 1 / 2 ) ω {\vert {i}_{p} \vert}^{2} Re ( {jKL}_{p} - {jMK}^{2} {Γ}_{L} ) \\ = ( 1 / 2 ) ω {\vert {i}_{p} \vert}^{2} [ - {L}_{p} \vert K \vert sin {θ}_{K} + M {\vert K \vert}^{2} \vert {Γ}_{L} \vert sin ( 2 {θ}_{K} + {θ}_{Γ} ) ] .\end{matrix} \qquad ( 48 )$$

The real power P_{L} at the load is:

$$\begin{matrix}{P}_{L} = ( 1 / 2 ) Re ( {v}_{s} {i}_{s}^{*} ) = ( 1 / 2 ) Re [ ( {Z}_{L} {i}_{s} ) {i}_{s}^{*} ] \\ = ( 1 / 2 ) Re [ ( jK ω {Mi}_{p} - j ω {L}_{s} {i}_{s} ) {( K {Γ}_{L} {i}_{p} )}^{*} ] \\ = ( 1 / 2 ) Re [ ( jK ω {Mi}_{p} - j ω {L}_{s} K {Γ}_{L} {i}_{p} ) {( K {Γ}_{L} {i}_{p} )}^{*} ] \\ = ( 1 / 2 ) ω {\vert K \vert}^{2} {\vert {i}_{p} \vert}^{2} Re ( jM {Γ}_{L}^{*} ) \\ = ( 1 / 2 ) ω {\vert K \vert}^{2} {\vert {i}_{p} \vert}^{2} M \vert {Γ}_{L} \vert sin {θ}_{Γ} .\end{matrix} \qquad ( 49 )$$

The power difference (P_{L}−Pₚ) becomes:

P_{L}−Pₚ=(½)ω|iₚ|²|K|²M|Γ_{L}|sin θ_{Γ}

−(½)ω|iₚ|²[⁻Lₚ|K|sin θ_{K}+M|K|²|Γ_{L}|sin(2θ_{K}+θ_{Γ})]

=(½)ω|iₚ|²[M|K|²|Γ_{L}|sin θ_{Γ}−M|K|²|Γ_{L}|sin(θ_{Γ}+2θ_{K})+Lₚ|K|sin θ_{K}]. (50)

The power difference becomes positive if the following condition is satisfied:

M|K|²|Γ_{L}|sin θ_{Γ}−M|K|²|Γ_{L}|sin(θ_{Γ}+2θ_{K})+Lₚ|K|sin θ_{K}>0. (51)

K is expressed as follows:

K=|K|exp(jθ_{K})=1/[1−Γ exp(− [symbol] )]

=1/{1−|Γ|exp(− [symbol] )exp[j(θ_{R}−ϕ)]}, (52)

where θ_{R} is the phase of the reflection coefficient Γ which is defined as follows:

Γ=|Γ|exp(jθ_{R})=(Z₂−Z₁)/(Z₂+Z₁), (53)

where Z₁ and Z₂ are the intrinsic impedances of the material of the magnetic core and air, respectively, and are defined as follows:

Z₁=\sqrt{=jwμ₁/(σ₁+jwε₁)}, (54)

Z₂=\sqrt{jwμ₂/(σ₂+jwε₂)}. (55)

where μ₁ and μ₂ are the permeabilities of the material of the magnetic core and air, respectively, α₁ and σ₂ are the conductivities of the material of the magnetic core and air, respectively, and ε₁ and ε₂ are the permittivities of the material of the magnetic core and air, respectively.

Usually, the magnitude |Γ| of the reflection coefficient is less than or equal to 1, and let us assume the following:

|Γ|≤1. (56)

Therefore,

|Γ|exp(− [symbol] )<1. (57)

As the relative phase ϕ is adjusted to a desired value by controlling the frequency, the possible values of |Γ|exp(− [symbol] )exp[j(θ_{R}−ϕ)] make a circle with a radius of less than 1 in the complex plane, and the circle A is expressed as follows:

A=|A|exp(jθ_{A})=|Γ|exp(− [symbol] )exp[j(θ_{R}−ϕ)], (58)

where θ_{A} is the phase of A.

Let the denominator of K be expressed as follows:

B=|B|exp(jθ_{B})=1−A=1−|Γ|exp(− [symbol] )exp[j(θ_{R}−ϕ)], (59)

where θ_{B} is the phase of B.

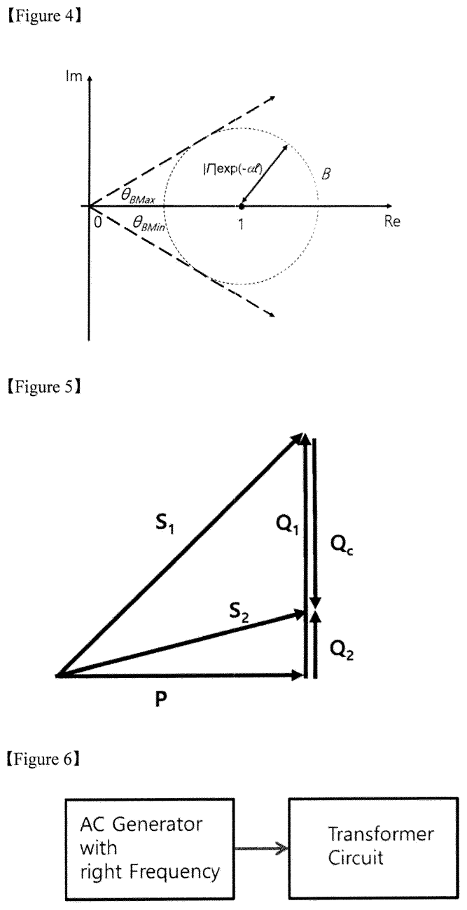

FIG. 4 shows values of the denominator of K represented as a circle with the radius of |Γ|exp(− [symbol] ).

The values of B which is the denominator of K constitute a circle in the complex plane as shown in FIG. 4. Therefore, the range of |B| becomes:

1−|Γ|exp(− [symbol] )≤|B|≤1+|Γ|exp(− [symbol] ). (60)

Also, the maximum and the minimum values of the phase, θ_{Bmax} and θ_{Bmin}, respectively, that B can have lie in the first and the fourth quadrants, respectively. Then, since the following holds,

K=1/B=(1/|B|)exp(−jθ_{B}), (61)

the phase θ_{K} of K also lies in the first or the fourth quadrant. Also, the magnitude of K lies in the following range:

1/[1+|Γ|exp(− [symbol] )]≤|K|≤1/[1−|Γ|exp(− [symbol] )]. (62)

Let us assume that |K| has a value as follows:

|K|>1. (63)

The phase θ_{Γ} has nothing to do with the relative phase, but is related to the load of the circuit, the self-inductance of the secondary coil, and the mutual inductance. If the value of the load Z_{L} is a real number as if it is comprised of resistance only, when the frequency is high, θ_{Γ} converges to zero. Therefore, let us assume:

θ_{Γ}≈0. (64)

Then the condition for which the power difference (P_{L}−Pₚ) is positive becomes:

M|K|²|Γ_{L}|sin θ_{Γ}−M|K|²|Γ_{L}|sin(2θ_{K}+θ_{Γ})+Lₚ|K|sin θ_{K}=−M|K|²|Γ_{L}|sin(2θ_{K})+Lₚ|K|sin θ_{K}>0. (65)

To find an instance that satisfies the condition above, let us assume that θ_{K} is an angle in the fourth quadrant with magnitude less than (π/4):

−π/4<θ_{K}<0. (66)

Then the following is satisfied:

sin(2θ_{K})<sin θ_{K}<0. (67)

Let the ratio D be defined as follows:

D=sin(2θ_{K})/sin θ_{K}>1. (68)

Then, the condition to make the power difference positive becomes:

−M|K∥Γ_{L}|D+Lₚ<0. (69)

But, if the load is a resistor and Z_{L} is a real value, then |Γ_{L}| at high frequency becomes as follows:

|Γ_{L}|=jωM/(jωLₛ+Z_{L})≈M/Lₛ. (70)

Then, the condition to make the power difference positive becomes:

−M²|K|D/Lₛ+Lₚ=−c²LₚLₛ|K|D/Lₛ+Lₚ=−c²Lₚ|K|D+Lₚ<0, (71)

where c is the coupling coefficient between the primary coil and the secondary coil. Therefore, if the following condition is satisfied, the power difference becomes positive in this case:

c²|K|D>1. (72)

In general, as the coupling coefficient is close to 1 and the values of |K| and D are larger than 1, it is not difficult to satisfy the condition above. Therefore, in a transformer circuit in the open loop configuration with a bar type core, the power difference can be made positive.

So far, a transformer with a bar type core in an open loop configuration is given as an example to show that impedance and power are dependent on the relative phase. Equations can be derived by considering the phase change that occurs when the flux propagates through the magnetic core for the transformers with other types of open or closed loop configurations. Therefore, as we can describe the dependency of impedance and power on the relative phase, the principle of the invention can be applied to all the transformers with the magnetic core in any configuration—open or closed—where the primary and the secondary coils are placed at certain positions in the magnetic core.

### B. Power Factor Correction in a Power Generating Transformer System (PGTS)

In electric power calculation, apparent power (S), real power (P), and reactive power (Q) have the following relation:

S²=P²+Q² (73)

When the angle between P and S is θ, the power factor is cos θ, and

cos θ=P/S. (74)

Also, the angle θ is the difference between the phase of the voltage and that of the current in the circuit.

In general, the traditional power factor correction is done to make the power factor maximized so that the magnitude of the reactive power is minimized.

FIG. 5 shows a power triangle and an illustration of the power factor correction. P is the real power, Q₁ is the original reactive power, and S₁ is the original apparent power before power factor correction. Q₂ is the new reactive power, and S₂ is the new apparent power after a power factor correction with an added reactive power Q_{c}.

Let us consider an example case of the traditional power factor correction in FIG. 5. Let P be the real power, and let S₁ and Q₁ be the original apparent power and the reactive power before the power factor correction, respectively. The power supply provides the apparent power S₁ in this case. Let us assume that the reactive power is changed to Q₂ by adding the reactive power Q_{c} to the circuit. Then the apparent power becomes S₂ in that case, which is desirable as the power supply provides less apparent power, accomplishing “power factor correction.”

There are ways to have the power factor corrected: passive power factor correction, active power factor correction, and dynamic power factor correction, etc. Although all of them can be used in correcting the power factor of the TC described in this invention, we will use the simplest one as an example to show the concept of the invention.

For instance, the simplest method is to add a passive reactive component such as a capacitor or an inductor to the circuit to reduce the total reactance. Then, the added reactive component(s) will supply the reactive power to meet the needs of the reactive load. In this way, as the power supply does not have to provide the unnecessary reactive power at the load, the apparent power can be reduced.

In an alternating current circuit, the real power is an integral of the multiplication of the voltage and the current waves averaged over a complete cycle. If the impedance lies in the first or the fourth quadrant in the complex plane of the impedance, the integral value always becomes non-negative, resulting in power consumption. If, however, there is a way to make the impedance lie in the second or the third quadrant, the integral value becomes negative and power is generated. In that case, the power factor will become negative, and power will flow back to the source.

The derivation of the new equations of a transformer circuit, including Equation (21) above, allows the impedance of the transformer circuit to be placed in the second or the third quadrant in the complex plane of the impedance. The impedance can be adjusted by controlling the relative phase ϕ of the flux. (Aquila H. Lee, Hijung Chai, and Won Don Lee, “An exploration of the phase dependency of a transformer circuit,” Proceedings of the 2019 IEEE Eurasia Conference on IOT, Communication and Engineering (ECICE), Yunlin, Taiwan, Oct. 3-6, 2019.) (Aquila H. Lee, Hijung Chai, and Won Don Lee, “Case studies of the impedance adjustment with phase control in a transformer circuit,” Proceedings of the 2019 IEEE Eurasia Conference on IOT, Communication and Engineering (ECICE), Yunlin, Taiwan, Oct. 3-6, 2019.)

One way to adjust the relative phase ϕ is to change the frequency feeding the transformer. Then the impedance of the TC is controlled according to Equation (21) or Equation (47).

There are many PGTS configurations that can be constructed to adjust the impedance using the equations derived in this invention. A basic configuration of a PGTS consists of, in general, an “AC generator with the right frequency (ACRF)” and a “transformer circuit (TC).” However, modules such as “monitoring control unit,” “amplitude and phase adjustment,” and others can be added for necessary operation as described in the PCT international patent application #PCT/KR2017/014540.

Although the power factor correction can be done in all of the configurations written in the PCT international patent application #PCT/KR2017/014540, we will use the simplest configuration to present the concept of the power factor correction in relation to the impedance adjustment of the TC.

FIG. 6 shows a power generating transformer system (PGTS). It consists of an “AC generator with right Frequency (ACRF)” and a “Transformer Circuit (TC).”

Let us consider a power generating transformer system (PGTS) in FIG. 6. The load in the PGTS can be in the primary circuit as well as in the secondary circuit of the transformer of the TC. The load can be AC electronic device(s) or DC device(s). If it is DC device(s), then a rectifier and a filter are necessary in the TC that converts AC to DC. Therefore, the TC mentioned here refers to a circuit which includes the necessary rectifier and filter when the load is DC device(s). For the sake of simplicity, let us consider the case where the load is in the secondary circuit of the transformer of the TC.

The impedance of the TC is measured at the primary coil of the transformer in the TC, but actually, anywhere between the place where AC or a pulse wave is generated in the ACRF and the primary circuit of the transformer of the TC can be chosen to measure the impedance to determine the right frequency for the desired relative phase and other values, and the principles described in this invention can be applied in the same way in that case also. For the sake of convenience, we choose the primary coil of the transformer in the TC to be the place to measure the impedance and the phase to explain the principles.

The method of the power factor correction is an established theory in the electrical engineering. The traditional power factor correction, however, deals mostly with the case when the power factor is between 0 and 1, that is, when the impedance lies in the first or the fourth quadrant of the complex plane of the impedance.

In the case when the phase of the impedance of the TC is 89 degrees, for instance, then the real power becomes a positive quantity close to zero. The reason why it becomes a small positive quantity is not because the amplitude of the current is minimized, but because of the difference between the phase of the voltage and that of the current. Although the real power becomes a small positive quantity, the ACRF still needs to generate the current with a large amplitude. Therefore, the ACRF becomes unnecessarily inefficient. That is why we need a power factor correction in a PGTS.

The impedance of the TC can be placed in the second or the third quadrant of the complex plane of the impedance, which makes the power factor to be negative. In that case, the real power at the primary coil of the transformer of the TC becomes negative as the phase of the impedance of the TC is over 90 degrees and less than 270 degrees.

A power factor can become negative having values from 0 to (−1) in the traditional settings, such as in the case of solar panels returning the surplus power back to the power supply. But, in that case, when the solar panel is regarded as the power supply, then the power factor becomes positive. In contrast, in a PGTS, however, the power factor becomes truly negative because of the phase change that occurs in the propagation of the flux in the magnetic core.

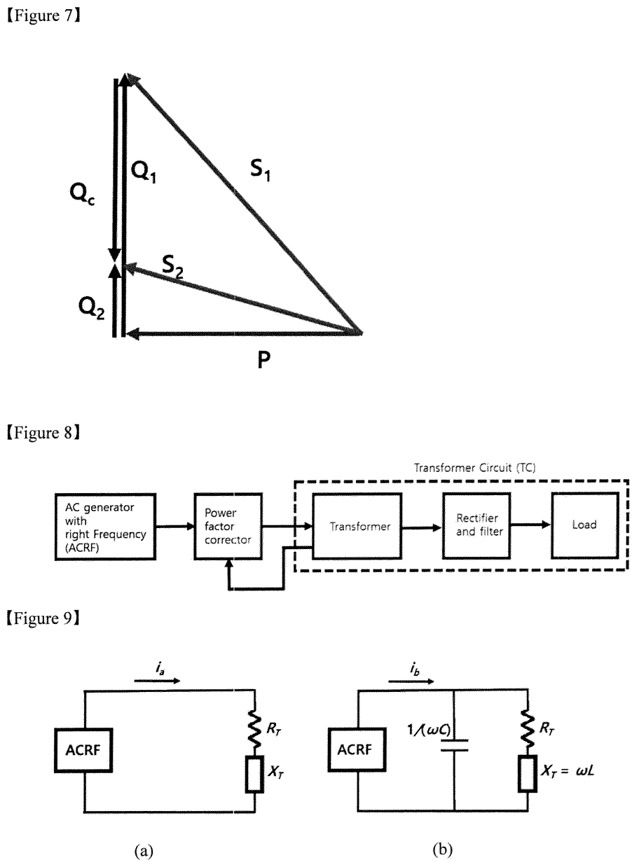

FIG. 7 shows a power triangle in the case when the power factor is negative.

In FIG. 7, the impedance is in the second quadrant of the complex plane of the impedance as the real power becomes negative and the reactive load is inductive. The reactive power Q₁ is changed to Q₂ by the power factor correction. By making the magnitude of the reactive power Q_{c} of the power factor corrector equal to that of the reactive power Q₁, the resultant reactive power Q₂ becomes zero.

FIG. 8 shows an example of a PGTS including a power factor corrector.

In FIG. 8, a block diagram of a PGTS including the power factor corrector is shown as an example. The dotted part corresponds to the TC. To simplify the diagram, the optional feedback from the TC to the ACRF is omitted as it is already explained in the PCT international patent application #PCT/KR2017/014540. A passive power factor corrector module can be realized by using one or more reactive component(s). The power factor corrector can be an active or dynamic one, in which case a feedback from the TC might be needed to get the information about the impedance or the powers of the TC. FIG. 8 depicts the case when such a feedback is necessary.

When a feedback is necessary, the information about the impedance of the TC can come from the primary circuit of the transformer of the TC as shown in FIG. 8, and such information can include the rms voltage vₗ(rms) at the primary coil of the transformer, the rms current iₚ(rms) in the primary circuit, and the real power Pₚ at the primary coil of the transformer as the magnitude |Zₚ| and the phase θₚ of the impedance Zₚ of the TC are related to them as follows:

|Zₚ|=vₗ(rms)/iₚ(rms). (75)

θₚ=a cos{Pₚ/[v₁(rms)iₚ(rms)]}. (76)

The information about the phase or the impedance of the TC can come from other parts of the TC. For instance, when we know the amount of the attenuation and the phase change that occur when the flux propagates through the magnetic core, the information from the secondary circuit side of the transformer can be used to calculate the impedance of the TC at the primary coil of the transformer using Equation (21). In that case, the feedback loop in FIG. 8 should be changed accordingly.

The power factor corrector can be placed in the secondary circuit of the transformer of the TC or anywhere when the information about the impedance of the TC is gained. Therefore, the power factor corrector can be placed in the primary circuit of the transformer or in any place in the PGTS once the information about the impedance of the TC is obtained from a certain location of the TC.

Power factor correction can be done not only at the primary circuit of the TC, but also at a different location. For example, at the point A in FIG. 1 where AC is generated, power factor correction can be done to minimize the magnitude of the reactive power.

Let us consider some cases when the power factor correction is needed in a PGTS:
1) In a PGTS, the ACRF provides the necessary power to the TC. Let W be the real power that the circuit of the ACRF consumes for producing the necessary waves for the TC. W does not include the power supplied to the TC. As the power difference (P_{L}−Pₚ) is the difference between the power at the load in the secondary circuit and that provided to the primary circuit of the transformer of the TC, usually it is negative. It becomes, however, positive when Equation (27) or Equation (51) is satisfied. If the power difference is positive, and if it satisfies the following condition, then the PGTS as a whole produces power:

(P_{L}−Pₘ)>W (77)
As there is a range of the relative phase that satisfies the condition above, there is a frequency range that corresponds to the range of the relative phase. Then power is generated when the ACRF generates a wave with a frequency in the range.
The real power that the TC consumes can have either positive or negative value when the condition above is satisfied. In this case, if the reactive power becomes zero by applying the power factor correction to the TC, then the power factor becomes 1 when the real power of the TC has positive value, and becomes (−1) when the real power of the TC has negative value.
2) If the impedance of the TC lies in the second or the third quadrant of the complex plane of the impedance, then the real power consumed by the TC becomes negative. In this case, if the power factor correction is done to make the reactive power to zero, then the power factor becomes (−1).
3) If the real power consumed by the TC is zero, then the power factor of the TC becomes zero. The reason why the real power consumed by the TC can be zero is that the flux undergoes the phase change when it propagates through the magnetic core. Although there is no resistance value of the impedance measured at the primary coil of the transformer of the TC, when the flux arrives at the secondary coil, the phase change causes the resistive value to appear, and the real power is dissipated at the load. In this case, when the reactive power becomes zero by applying the power factor correction, the amplitude of the current that the ACRF supplies can be made almost zero, and the efficiency is increased. An example for this case is described later.

Now, we will consider a specific example case. Although all kinds of power factor correction systems can be used for correcting the power factor of the all the possible configurations of a PGTS, we will give the simplest example to convey the idea of the invention.

FIG. 9 shows equivalent circuits of power generating transformer systems (PGTS). (a): The system without the power factor correction. (b): A capacitor with a capacitance of C is put in parallel for power factor correction of the TC. Here, ωL and 1/(ωC) are the inductive and capacitive reactances, respectively.

Let us consider a system in FIG. 9(a), where the impedance Z_{T} of the TC is expressed as:

Z_{T}=|Z_{T}|exp θ_{T}=R_{T}+jX_{T}, (78)

where θ_{T} is the phase of Z_{T}, and R_{T} and X_{T} are the resistance and the reactance of the TC seen at the primary coil of the transformer of the TC, respectively.

The phase of the impedance of a TC can be adjusted to a desired value by controlling the relative phase ϕ according to Equation (21) or Equation (47) or any other equation derived for a given configuration of the magnetic core. Without loss of generality, let us assume that the impedance of the TC is in the second quadrant of the complex plane of the impedance. (When the impedance of the TC is in the third quadrant, the same principle can be applied.) Then the TC has an inductive load in addition to the negative resistive load.

Now let us assume that a capacitor is put into the circuit as in FIG. 9(b). Then by applying the principle of the power factor correction the magnitude of the reactive power of the TC can be reduced and the ACRF can become efficient.

An interesting case arises when the resistance R_{T} of the impedance of the TC is zero as mentioned in the case 3) above. Although the load at the secondary side of the transformer of the TC is a purely resistive, the phase of the impedance of the TC can be set to 90 degrees by adjusting the relative phase.

Let the reactance of the capacitor be as follows:

1/(ωC)=ωL. (79)

Then, at the angular frequency of ω=1/\sqrt{LC}, resonance occurs, and the magnitude of the impedance of the TC combined with the capacitor becomes very large. Then the amplitude of the current i_{b} from the ACRF becomes very small compared with that of the current iₐ when the capacitor (power factor corrector) is not added. In this way, the ACRF does not have to consume much power to generate the current with a large amplitude. The capacitor (power factor corrector) provides the necessary reactive power that the inductive load of the TC requires.

Instead of putting the passive reactive component for the power factor correction, another method can be used such as active or dynamic power factor correction. For instance, when the transformer of the TC is connected to a rectifying circuit using diodes, as the diode is a non linear device, an active power factor correction might be useful. The above explanation using the capacitor as a passive power factor corrector is an example to show the concept of the invention.

The power factor corrector needs power to run before the PGTS can generate power, so an additional power supply on standby might be needed.

When the impedance of the TC is placed in the first or the fourth quadrant, the same principle can be applied. Then the power factor is between 0 and 1, and the power factor correction can be done as explained in FIG. 5. But this case also is different from the traditional power factor correction in that it tries not to remove the reactive power at the load in the secondary circuit but to remove the reactive power at the primary coil of the transformer of the TC or at the location where AC is generated.

The ACRF can become efficient as it does not have to supply a current with a large amplitude to the system when the power factor correction is applied as explained above.

Note that the power factor correction in this invention is different from the traditional power factor correction. The traditional power factor correction, when applied to a transformer circuit, is done under the assumption that there is no phase change when the flux propagates through the magnetic core. Therefore, the traditional power factor correction is done to minimize the magnitude of the reactive power at the load of the secondary circuit.

In this invention, however, the power factor correction is done not to minimize the magnitude of the reactive power at the load in the secondary circuit of the transformer of the TC, but to minimize the magnitude of the reactive power at the primary coil of the transformer of the TC or at the location where AC is generated.

Also, in this invention, power factor correction is done to make the power factor be (close to) 1 or (−1) according to the impedance of the TC, whereas the traditional power factor correction is to make the power factor be (close to) 1. Also, when the real power consumed by the TC is zero, a resonance circuit can be made so that the amplitude of the current that the ACRF provides becomes almost zero.

### C. Using a Material Having Slower Speed of the Flux in the Magnetic Core

In general, the ACRF in the PGTS generates and sends the voltage wave with a right frequency to the TC so that at the transformer of the TC the relative phase ϕ can be controlled.

As the phase change is necessary, there are three ways or the combinations of the three ways to accomplish it in a given transformer circuit: altering the length of the magnetic core and/or using different frequencies and/or adding the reactive components. Here, the length of the magnetic core means the length of the magnetic core through which the flux goes from the primary coil to the secondary coil.

The material used for the magnetic core of the transformer also matters in controlling the relative phase. As Equation (8) indicates, the relative phase ϕ is inversely proportional to the speed of the flux. The speed of the flux is related to the permeability, the permittivity, and the loss angles of the material. (Nannapaneni N. Rao, Fundamentals of Electromagnetics for Electrical and Computer Engineering, Chapter 5, Illinois ECE Series, available on the web: https://ece.illinois.edu/webooks/nnrao2009/Rao%20Fundamentals%202009%20full%20text.pdf) Therefore, choosing the right material for the magnetic core of the transformer is important to have sufficient phase change occur when the flux propagates.

The complex relative permittivity εᵣ and the complex relative permeability μᵣ are represented as follows, by their magnitudes together with their loss angles−the dielectric loss angle δₑ and the magnetic loss angle δₘ:

εᵣ=|εᵣ|exp(−jδₑ), (80)

μᵣ=|μᵣ|exp(−jδₘ). (81)

Then the speed v of the flux in the magnetic core becomes: (Jianfeng Xu et al., Complex Permittivity and Permeability Measurements and Finite-Difference Time-Domain Simulation of Ferrite Materials, IEEE Transactions on Electromagnetic Compatibility, Vol. 52, No. 4, November 2010. pp. 878-887.)

υ=c₀/[\sqrt{|εᵣ∥μᵣ|}cos(δₑ/2+δₘ/2)], (82)

where c₀ is the speed of light in free space.

For instance, in a material with a large magnitude of the complex relative permittivity, the speed of the flux might be considered slower, but the fact that the dielectric loss angle is also related to the speed should not be forgotten.

When trying to reduce the speed using a magnetic core with high permeability, as an adverse effect, the magnetic field B can be easily saturated. To reduce the speed and at the same time not to make the magnetic field be easily saturated, a core with an air gap can be used. (Radoslaw Jez, Aleksander Polit, Influence of air-gap length and cross-section on magnetic circuit parameters, Proceedings of the 2014 COMSOL Conference in Cambridge, Sep. 17-19, 2014, Churchill College.) A core with an air gap, in effect, has a reduced permeability value. Then, the phase change in the core and the non-saturation of the magnetic field can be obtained at the same time as the phase change is done mainly at the magnetic core where the permeability is high and the permeability is effectively lowered at the air gap of the core where the phase change is not significant.

Also, permittivity, permeability, and loss angles all depend on the frequency. And it is not good to have a large loss angle as it increases the loss in the core. Therefore, all these factors should be taken into account when selecting a material for the magnetic core so that the desired relative phase can be obtained.

In general, according to Equation (8), because the relative phase ϕ is inversely proportional to the speed of the flux, the slower the speed of the flux becomes, the larger the relative phase gets. If we select a material having slower speed of the flux, when other conditions remain the same, the relative phase becomes greater and it is easier to control the relative phase. Therefore, using such a material, the same relative phase can be achieved with a wave of a lower frequency or with a shorter magnetic core.

### D. Power Generating Wireless Power Transmission System

The core does not need to be a ferrite core. It can be air, and the same principles applied to a PGTS can be applicable to that case. When the core is air, the primary coil and the secondary coil of the transformer can be apart and it becomes a wireless power transmission system with inductive coupling.

A PGTS can be a wireless power transmission system if air is used as part of the core. In that case, not only power can be transferred wirelessly, but also the power at the transmitter can be zero or negative or lesser than the power dissipated at the load. In other words, the system becomes a power generating wireless power transmission system.

For example, one of the wireless power transfer methods, called as “magnetic resonance coupling,” to transfer power efficiently from the primary coil of the transmitter to the secondary coil of the receiver is to transfer power between the two resonant circuits of the transmitter and the receiver. (Stanimir S. Valtchev, Elena N. Baikova, Luis R Jorge, Electromagnetic Field as the Wireless Transporter of Energy, Facta Universitatis Ser. Electrical Engineering, Vol. 25 No. 3, December 2012, pp. 171-181.) (Sam Ben-Yaakov, A primer to wireless power transfer, youtube.com, https://www.youtube.com/watch?v=WUppQtV-A48&feature=youtu.be, Sep. 3, 2017.) (Oak Ridge National Laboratory, Wireless Power Transfer, Oak Ridge National Laboratory, youtube.com, https://www.youtube.com/watch?v=Gw6XtzEOlyI, Jul. 22, 2013.) By doing so, power can be transferred efficiently. If the frequency that makes the efficient wireless power transfer is set to the frequency that makes the relative phase to a desired one, not only is power efficiently transferred wirelessly, but the power factor can also be set to a desired value.

The phase of the flux changes even in air in the case of the wireless power transfer. As the speed of the electromagnetic wave in air is very fast, a high frequency should be used to make the desired phase change. In this case, the impedance is controlled by the relative phase ϕ according to Equation (21).

The core can consists of air and other materials. As already mentioned, when there is an air gap, the core consists of air and a substance such as a ferrite material. In the case of the wireless power transfer, the air gap is very large.

In that case, for instance, as in FIG. 3, the primary coil is wound over a bar type ferrite core and power is transferred wirelessly to the secondary coil through the air gap of the core. And the core at the secondary coil can be any other material such as ferrite or can be air.

One instance of such wireless power transmission systems is the “dipole coil resonance system (DCRS).” (Changbyung Park, Sungwoo Lee, Gyu-Hyeong Cho, Chun T Rim, Innovative 5-m-off-distance inductive power transfer systems with optimally shaped dipole coils, IEEE transactions on power electronics, Vol. 30, No. 2, pp. 817-827 2014.) In that case, the primary coil of the transmitter side is wound over a bar type core as in FIG. 3, and the secondary coil of the receiver side is also wound over a bar type core.

In that case, there is a phase change when the flux propagates through the bar type of magnetic core. At the end of the core, when the amount of the reflected flux is small, the flux propagates through air and goes to the secondary coil. As the speed of the flux in air is very fast, the phase change through the air core is not big when compared with that through the magnetic core and can be ignored in general.

The flux arrives to the secondary coil of the receiver side through the bar type core after a phase change. If the reflection of the flux at the end of the bar of the primary side can be ignored, and if the reflection of the flux that occurs when the flux enters from air into the bar type core of the secondary side can be ignored, and if all the other reflections that occur in the core can be ignored, then the transmission coefficient of the flux when it goes to air at the end of the bar type core of the primary side and the transmission coefficient of the flux when it enters into the bar type core from air at the secondary side should be multiplied to the amount of the flux arriving at the secondary coil of the receiver in Equation (9).

Then, at the secondary coil, the flux in the backward direction is formed as in Equation (14) and undergoes a phase change as it propagates through the bar type core of the secondary circuit, and propagates through air, and comes to the bar type core of the primary side and undergoes a phase change as it propagates through it, and arrives at the primary coil. In other words, as this whole process and the phase change and the impedance can be described by the equations derived already in the above, a wireless power transmitter and receiver system can be converted to a PGTS using an appropriate frequency that accomplishes a desired phase change.

In the case above, if there are significant reflections of the flux at the end of the magnetic core, all of the reflected waves should be summed together as in Equation (36). The reflections that take place when the wave propagates from air to the magnetic core can be taken care of in the same way. Therefore, the equations for a PGTS which has a magnetic core with a closed or an open loop configuration and has a primary or a secondary coil placed at any location in the core, can be derived when the attenuation and the phase change of the flux when it propagates through the core are considered and when the total wave at the primary or the secondary coil is calculated to be the sum of the transmitted wave and all the reflected waves.

When a material such as ferrite is used as the magnetic core, the speed of the flux can be lower than that in air, and power can be transferred with a wave of a lower frequency. When a relatively low frequency is used in the wireless power transfer, the phase change taking place in air can be neglected as it is much smaller than that taking place in the magnetic core. And the receiver can have a magnetic core to achieve the desired phase change. Of course, either the transmitter or the receiver or both can be magnetic cores to achieve the phase change. In this way, by using the wave with an appropriate frequency which not only achieves the desired relative phase but also transfers power wirelessly, a system can be a PGTS as well as a wireless power transmission system.

When the core consists of air and one or more materials of the magnetic core(s), the reflection coefficient and the transmission coefficient should be chosen to efficiently transfer power wirelessly.

The speed of the flux in the magnetic core is determined by Equation (82), and it is related to the permeability and the permittivity of the material, and the reflection coefficient and the transmission coefficient are related to the intrinsic impedance of the material which, according to Equation (54) and Equation (55), is dependent on the permeability, the conductivity, and the permittivity of the material. As seen in Equation (82), the square of the speed of the flux is inversely proportional to the magnitude of the product of the permeability and the permittivity. And as seen in Equation (54), when the conductivity is neglected, the square of the intrinsic impedance is proportional to the ratio of the permeability to the permittivity. Thus, there can be a material with a transmission coefficient which not only has a slow speed of the flux to make the relative phase controlled easily but also efficiently transfers power wirelessly.

The principles in this invention and in the PCT international patent application #PCT/KR2017/014540 can be applied not only when the magnetic core is a material, but also when the core consists of air and other materials. Therefore, in this invention, the PGTS includes all the systems that work based on the same principles having all sorts of magnetic cores of closed or open loop configurations including Power Generating Wireless Power Transmission System having air as part of the core.

E. Modifying a Machine with a Transformer to a PGTS

The principles discussed in the following can be applied not only to an SMPS but also to a machine, for instance, having half-bridge or H-bridge (full-bridge) topology or any other topology and having a transformer, which generates the backward flux at its secondary coil of the transformer according to Equation (14) when a pulse wave or a sinusoidal wave or any periodic wave is input. But to explain the principles how to convert a machine to a PGTS, an SMPS is used as an example. All the applicable principles can be applied to other types of machines in the same way.

Also when there are other additional functions that these machines have, and if those functions are useful for a PGTS, then those can be added to the PGTS easily. For instance, an SMPS has a regulated output voltage and can have the undervoltage-lockout (UVLO) and other functions, and those functions can be used as they are when an SMPS is converted to a PGTS.

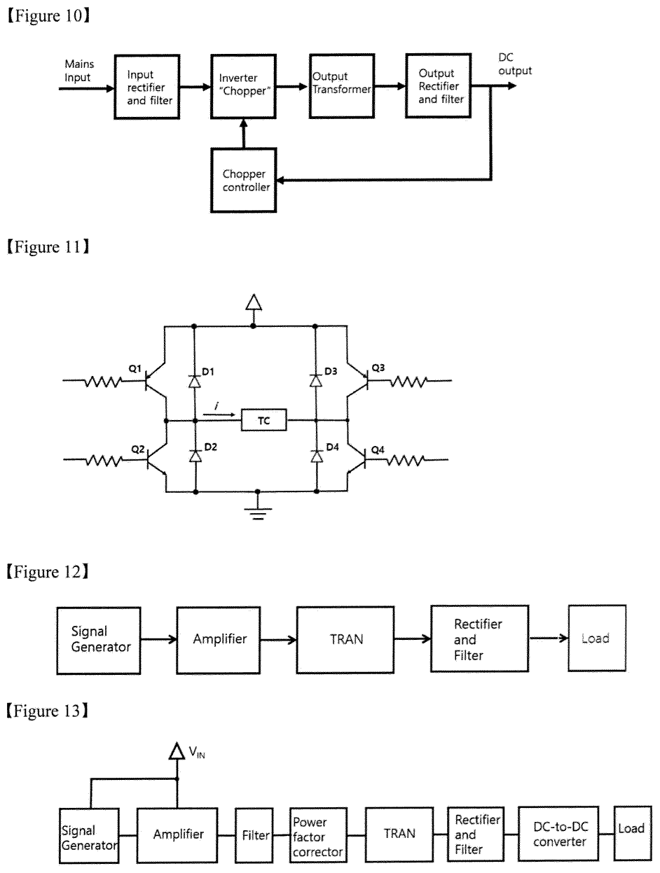

FIG. 10 shows a switched mode power supply with a transformer. The feedback loop is optional and is used when the DC output needs to be monitored for a regulated output. When the input is AC, the input rectifier and filter is needed, whereas for a DC input, it is not needed.

An SMPS is used to supply power from a DC or AC source to DC load. Its basic structure is in FIG. 10. In general, an SMPS can be categorized into two types: those with non-isolated topologies and those with isolated topologies. All of the SMPSs with isolated topologies have an output transformer. We will discuss only about any SMPS with a transformer which generates the flux propagating in the backward direction at the secondary coil as in Equation (14) in this invention.

When we compare a PGTS with an SMPS, they have similar functions. In an SMPS shown in FIG. 10, the function of the combined modules of “input rectifier and filter,” “inverter chopper,” and “chopper controller” can be regarded similar to that of the ACRF in a PGTS.

The wave coming out of the “inverter chopper” or the ACRF has a sinusoidal or a pulse or some kind of waveform. In general, as an arbitrary wave can be represented as a Fourier series composed of sinusoidal waves with different frequencies, and as the length of the magnetic core is not long to make the wave distorted much, any form of wave can be used in making a PGTS. Therefore, in FIG. 1, vₚ does not have to be sinusoidal, and can have any periodic waveform.

The “output transformer” in an SMPS corresponds to the transformer of the TC in a PGTS. The “output rectifier and filter” in an SMPS corresponds to the “rectifier and filter” in a PGTS. Therefore, the attenuation and the phase change that occur when the flux propagates through the magnetic core also occur in an SMPS with a transformer.

The main difference between an SMPS and a PGTS is that an SMPS is constructed as a power supply to supply power to the load, while a PGTS is for generating the necessary power to supply power to the load. An SMPS does not use the fact that the flux has phase change when it propagates through the magnetic core, while a PGTS utilizes that fact so that it makes the power factor of the TC be (close to) 1 or (−1) depending on the conditions.

As mentioned already, while an SMPS and other devices try to make the power factor correction on the output load at the secondary circuit side of the transformer circuit, a PGTS tries to correct the power factor at the primary coil of the transformer of the TC or at the location where AC is generated.

An SMPS uses high frequency not to set the relative phase to a desired value, but mainly to reduce the transformer size being used. Also, the length of the magnetic core from the primary coil to the secondary coil of the transformer used in most of the SMPSs does not have enough length to change the phase of the flux. Although some of the SMPSs might have long enough magnetic path length, they do not utilize the phase change that occurs during the propagation of the flux through the magnetic core.

If we want to modify an SMPS to a PGTS, then many different configurations can be made by combining the parts described in the PCT international patent application #PCT/KR2017/014540, but basically the followings should be done:
a) Sufficiently high frequency should be used to make the necessary relative phase ϕ, and when necessary, the relative phase ϕ should be controlled by changing the frequency.
b) A transformer which can have a sufficient phase change when the flux propagates should be used. In order to have a sufficient phase change, the magnetic path length should be sufficiently long, and/or the material that makes the speed of the flux slow should be used for the core of the transformer so that the relative phase becomes relatively large and its change is evident.
c) Relative phase should be adjusted so that Equation (77) is satisfied, or
d) the impedance of the TC is placed at the second or the third quadrant, or
e) the real power consumed by the TC is zero.
f) Also, the power factor correction should be done not at the secondary output load, but at the primary coil of the transformer or at the location where AC is generated in an SMPS as explained above if efficiency is to be increased.
g) When necessary, a filter circuit to change the wave coming out of the “inverter chopper” to a sinusoidal one might be needed. In that case, a filter circuitry can be inserted between the “inverter chopper” and the “output transformer” in an SMPS or a modulator such as a sinusoidal pulse width modulator (M. H. Rashid, Power Electronics Handbook, Academic Press, 2001, p. 226.), or an enhanced pulse width modulator (EPWM) (Using the ePWM Module for 0%-100% Duty Cycle Control, Application Report, Literature Number:SPRAAI1, Texas Instruments, December 2006.), etc., can be used as the “chopper controller” to generate sinusoidal waves.

Next, when power comes back from the primary circuit of the transformer in the TC to the power source, in order to utilize the power the path for the power to return to the power source needs to be made.

FIG. 11 shows a switch part of an ACRF of a PGTS in the form of H-bridge.

For instance, let us consider the case when the switch part of the ACRF of a PGTS is in the form of H-bridge (full-bridge) and is connected to the TC as in FIG. 11. Here, the switches of H-bridge consist of the transistors Q1 to Q4.

When Q1 and Q4 are on and Q2 and Q3 are off, the current i can flow from the source to the TC in the forward direction or from the TC to the source in the backward direction. When the current flows from the TC to the source, the diodes D1 and D4 are necessary to make the path for the current to flow in the backward direction.

Now, when Q2 and Q3 are on and Q1 and Q4 are off, the current i can flow from the source to the TC or from the TC to the source. When the current flows from the TC to the source, the diodes D2 and D3 are necessary to make the path for the current to flow. When the power factor of the TC has a negative value, power flows in the backward direction on the average, and by making the return path for the current in this way, the power coming backward can be utilized.
h) Therefore, when converting a machine with a transformer to a PGTS, the return current path needs to be made so that power can flow backward.

Some of the SMPSs have the power factor corrector module in it. One of the reasons to put the power factor corrector in an SMPS is to limit the harmonic content of the input current. (J. M. Bourgeois, Circuits for power factor correction with regards to mains filtering, Application Note, STMicroelectronics, 1999.) Although the power factor corrector in an SMPS is to make the supply current waveform to be sinusoidal and in phase with the supply voltage so that the magnitude of the reactive power at the load be minimized, the main purpose of the power factor corrector in an SMPS is different from that of the power factor corrector in a PGTS in this invention.

For example, when the real power consumed by the TC is negative, the power factor corrector in a PGTS makes the reactive power at the primary coil of the transformer of the TC be (close to) zero, in which case the difference between the phase of the voltage and that of the current is (close to) 180 degrees at the primary coil of the transformer. This is in contrast with the power factor corrector in an SMPS which tries to make the difference between the phase of the voltage and that of the current be zero.

As we already mentioned in the simple example case above as in FIG. 9, by putting a capacitor in parallel with the primary coil of the transformer of the TC where the capacitor resonates at the frequency when the phase of the impedance of the TC is 90 degrees, the amplitude of the current coming from the ACRF of the PGTS can become (almost) zero as the magnitude of the impedance of the parallel LC circuit becomes very large at the resonance frequency. And the resistance of the TC is effectively zero as the phase of the impedance is 90 degrees.

Note that, although the resistance at the primary coil of the transformer of the TC is zero in the case above, the resistive load at the secondary circuit remains the same, and power is dissipated at the load.

### F. PGTS as a Power Supply

When Equation (77) is satisfied, a PGTS becomes a power generator. Although Equation (77) is not satisfied, by controlling the relative phase ϕ, the impedance of the TC can be adjusted so that the power dissipated at the load becomes equal or more than before while the ACRF supplies less power to the TC. By doing so, a PGTS can be used as a power supply as well as a power generator.

The power Pₙ that the ACRF supplies to the TC is:

Pₙ=Pₘ+W (83)

Therefore, at a certain frequency f₀, when power is generated, the following is true:

P_{L}(f₀)−Pₙ(f₀)>0, (84)

where P_{L}(f₀) represents the power at the load and Pₙ(f₀) is the power Pₙ at the frequency f₀. Also, let us assume that at frequencies f₁ and f₂, power is not generated, then the following relations hold:

P_{L}(f₁)−Pₙ(f₁)=P_{A}<0, (85)

P_{L}(f₂)−Pₙ(f₂)=P_{B}<0. (86)

Without loss of generality, let us assume the following:

P_{A}<P_{B}. (87)

Then,

[P_{L}(f₂)−P_{L}(f₁)]−[Pₙ(f₂)−Pₙ(f₁)]=P_{B}−P_{A}>0, (88)

ΔP_{L}=[P_{L}(f₂)−P_{L}(f₁)]>[Pₙ(f₂)−Pₙ(f₁)]=ΔPₙ. (89)

Let us further consider the case as follows:

P_{L}(f₂)>P_{L}(f₁), (90)

and

Pₙ(f₂)>Pₙ(f₁)>0. (91)

Then, Equation (89) says that when the frequency changes from f₁ to f₂, the difference ΔP_{L} of the powers at the frequency f₂ and at f₁ at the load becomes larger than the difference ΔPₙ of the powers that the ACRF provides to the TC. This is possible because the impedance is adjusted by controlling the relative phase ϕ. That is, by controlling the relative phase, more power can be dissipated at the load while providing less power. Therefore, a PGTS can not only be a power generator but also be a power supply to provide more power dissipated at the load while supplying less power. In this way, a PGTS can be a power supply or a power generator.

### G. Power Factor Correction in a PGTS as a Power Supply

In the extended application of a PGTS as a power supply, the same principle mentioned above for the power factor correction can be applied to reduce the apparent power that the ACRF supplies, thereby making it efficient.

H. Modifying a Machine with a Transformer to a PGTS Functioning as a Power Supply

As mentioned already, an SMPS and other machines with transformers which generate the flux going backward direction when a train of pulses or sinusoidal wave or a periodic wave is input can be modified to a PGTS. Therefore, a machine with a transformer can be converted to a PGTS as a power supply and then by controlling the amount of the phase change of the flux, it can consume less power as a power supply. In order to do that, as mentioned above, a machine with a transformer should be able to control the relative phase ϕ when necessary.

Below, some block diagrams of power generating transformer systems (PGTSs) are shown.

I. Block Diagrams of a PGTS without Feedback

A PGTS consists of an “AC generator with right frequency (ACRF)” and a “transformer circuit (TC)” as shown in FIG. 6. An ACRF consists of a “signal generator” and an “amplifier.” In the ACRF module, the signal generated by the “signal generator” is amplified by the “amplifier,” and the wave with the right frequency for the magnetic flux to have the necessary phase change in the core of the transformer (from now on, the transformer in the TC is denoted as “TRAN”) is generated. A TC consists of a TRAN and a “rectifier and filter” module, and a load. Here, it is assumed that the load requires a DC power. If the load requires an AC power, then an inverter is necessary to convert DC to AC. The magnetic flux due to the wave generated by the ACRF undergoes a phase change in the core of the TRAN in the PGTS. Therefore, the TRAN in this invention is the transformer with a sufficient length of magnetic core to accomplish the necessary phase change of the magnetic flux, and should be differentiated from a general transformer with a short length of the magnetic core.

FIG. 12 shows a block diagram of a power generating transformer system (PGTS).

A block diagram for a PGTS can be drawn to consist of a “signal generator,” an “amplifier,” a “TRAN,” a “rectifier and filter,” and a “load” as shown in FIG. 12.

As described in the documents of PCT international patent application #PCT/KR2017/014540, reactive component(s) may be inserted before or after the TRAN in FIG. 12 to get the desired phase of the impedance of the circuit. Throughout the invention, however, the reactive component(s) for changing the phase of the impedance of the circuit is omitted in the diagrams for the sake of simplicity. Also, the input voltage and the signal ground are omitted for the sake of simplicity in FIG. 12.

FIG. 13 shows a block diagram of a PGTS without feedback.

A more detailed block diagram of a PGTS is depicted in FIG. 13. From now on, the block diagrams are drawn with lines without arrows as the directions of the flows between modules are apparent. In this invention, it is assumed that the signal generator, the amplifier and the load are DC powered, and V_{IN} in FIG. 13 is the input DC voltage. The input voltage V_{IN} can be, for instance, provided by a battery or by a hand crank generator. Not only the amplifier needs input voltage V_{IN}, but also the signal generator needs input voltage which can be different from V_{IN}. When the voltage the signal generator needs is different from V_{IN}, the voltage should be adjusted to an appropriate level in the signal generator.

If only an AC source is available as input, converting AC to DC can be done easily through the rectification process. Illustration of the necessary rectification module is omitted for the sake of simplicity. Likewise, if any module needs an AC source, then converting DC to AC can be done by a power inverter. The necessary power inverter in such case is omitted in the block diagrams for the sake of simplicity.

In the following discussion, each module in FIG. 13 is described from the left to the right.

1) Signal Generator

The signal generator generates a periodic signal such as, for instance, a sinusoidal or a pulse wave with the right frequency. When a wave consists of some different frequencies, there is a dispersion. When a wave is dispersed in the medium, the degree of distortion of the shape of the wave can be tolerable if the length of the magnetic core of the TRAN in the PGTS is not long. This is because the matter of concern is not the conservation of the exact shape of the waves, but the power which is related to the multiplication of the voltage and the current waves.

Although the waves get some distortion, when the voltage and the current waves are multiplied and integrated together, there still can be negative values coming out as a result on average. Therefore, even if a pulse wave is used as the signal, the PGTS can generate power. If desired, a filter can be used to remove the high frequency components of the pulse wave.

2) Amplifier

The amplifier amplifies the signal generated from the signal generator. Any amplifier that amplifies the incoming signal can be used, but it is better to use an efficient one. For instance, a class-D amplifier has a theoretical power efficiency of 100%. (Jun Honda and Jonathan Adams, Class D audio amplifier basics, Application note AN-1071, International Rectifier, 2005.)

Among the many configurations, a specific type of the class-D amplifier has a half-bridge or a full-bridge (H-bridge) configuration. In the block diagrams in this invention, a half-bridge or a full-bridge is used as the amplifier as an example. Note, however, that any amplifier regardless of the class can be used here if it is an efficient one.

A PGTS can be implemented even with an inefficient amplifier. For instance, as already discussed in relation to FIG. 9(b), the apparent power provided from the ACRF can be very small when the power factor corrector is attached. Therefore, although the amplifier is inefficient, the PGTS can be realized with it.

3) Filter

If the output of the amplifier needs to be sinusoidal or if some of the unwanted frequency needs to be removed, a filter is added after the amplifier as shown in FIG. 13. However, as the output of the amplifier does not need to be sinusoidal, this filter may be omitted.

4) Power Factor Corrector

The power factor correction in PGLS is already explained above. If an active power factor corrector is used, for instance, then the input power supply needs to be connected to the power factor corrector also. The power factor corrector is added when desired, and hence, is optional.

5) TRAN

As mentioned already, the TRAN has a sufficient length of magnetic core to accomplish the phase change. The magnetic core of the TRAN can have an open loop or a closed loop configuration. In the case of the power generating wireless power transmission system, it can have up to two magnetic cores with an air gap between them.

The powers delivered from the source and to the load are proportional to the square of the amplitude of the primary current of the TRAN as shown in Equations (23), (25), (48), and (49). Once the mutual inductance and the impedances of the primary and the secondary circuits of the TRAN and the load are determined, the amplitude of the primary current of the TRAN can be maximized by adjusting the frequency and the output impedance seen by the TRAN toward the source.

6) Rectifier and Filter

The output of the TRAN is an AC wave, and needs to be rectified and filtered to convert AC to DC. Examples of the rectifier and the filter are a bridge rectifier and a capacitor, respectively.

7) DC-to-DC Converter

A DC-to-DC converter is needed after rectification and filtering are completed as the voltage should be adjusted to the level that the load requires. If the impedance of the load stays constant over time and if the output voltage of the “rectifier and filter” is the voltage that the load requires, then this DC-to-DC converter can be omitted.

An example of a DC-to-DC converter is the switched-mode power supply (SMPS). (Mohammad Kamil, AN1114, Switch Mode Power Supply (SMPS) Topologies (Part I), Microchip Technology Inc., 2017.)

In the examples of the block diagrams, an SMPS is used as the DC-to-DC converter as an example. There are many topologies of the SMPS, and any of them can be used if the SMPS gives out the output voltage that the load requires. Even a commercially available off-the-shelf DC-to-DC converter or an SMPS product can be used.

Some desirable features such as over current, over temperature, over voltage, short circuit, and surge protections as well as undervoltage-lockout can be inserted in the DC-to-DC converter, and are readily available in the commercial off-the-shelf products.

8) Load

The load dissipates power out of the DC-to-DC converter.

The PGTS described in FIG. 13 does not have a feedback loop from the output of the TC back to the system. The PGTS without feedback shown above corresponds to the long-life battery system when the input is from a battery as described in the document of PCT international patent application #PCT/KR2017/014540.

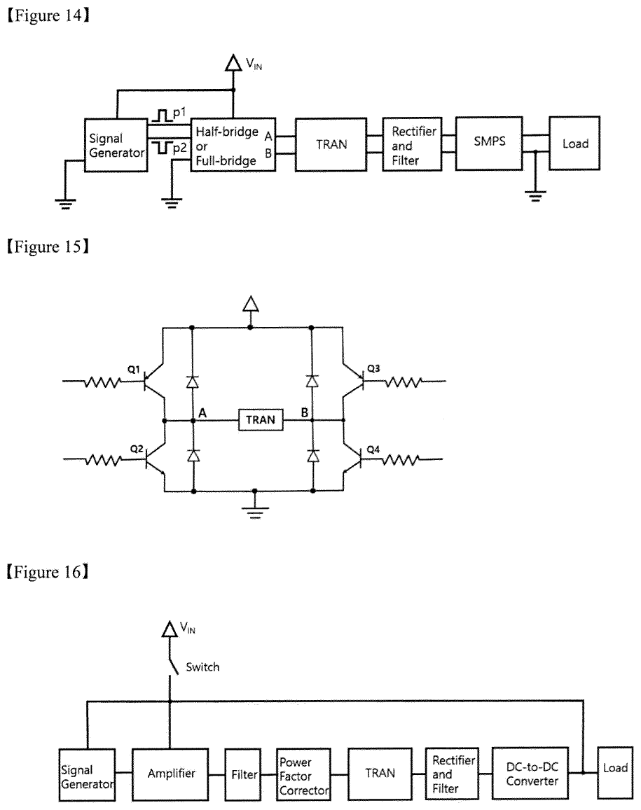

FIG. 14 shows an example of a block diagram of a PGTS without feedback with a half-bridge or a full-bridge as the amplifier and with an SMPS as the DC-to-DC converter.

FIG. 14 shows an example of a block diagram of a PGTS without a feedback loop with a half-bridge or a full-bridge as the amplifier and with an SMPS as the DC-to-DC converter.

FIG. 15 shows a full-bridge connected to a TRAN.

FIG. 15 shows a full-bridge connected to a TRAN. The signal generator generates two pulse waves, p1 and p2, in FIG. 14. When p1 is high, the transistors Q1 and Q4 in FIG. 15 are on, while Q2 and Q3 are off. When p2 is high, the transistors Q2 and Q3 are on, while Q1 and Q4 are off. Pulse waves p1 and p2 should be carefully generated not to cause a shoot-through which takes place when either both Q1 and Q2 or both Q3 and Q4 are on at the same time.

Points A and B in FIG. 14 corresponds to the points A and B in FIG. 15, respectively. In FIG. 15, only the two input terminals of the TRAN are shown, and the output terminals of the TRAN are not shown.

It is better to use an SMPS with an isolated topology as the DC-to-DC converter when a half-bridge or a full-bridge is used. This is because the ground of the primary side of the TRAN is different from that of the secondary side of the TRAN. Usually a transformer is used for the isolation in an SMPS. By using an isolated SMPS, the ground of the load can be connected to the ground of the signal generator or the amplifier which is a half-bridge or a full-bridge in this case. The ground connections are illustrated in FIG. 14 for clarification.

J. Block Diagrams of a PGTS with Feedback

FIG. 16 shows a block diagram of a PGTS with feedback.

FIG. 16 shows a block diagram of a PGTS with a feedback loop. In the diagram, the signal ground is omitted for the sake of convenience. The output of the DC-to-DC converter is fed back to the amplifier. The output of the DC-to-DC converter should also be connected to any module that needs power. For instance, if an active power factor corrector is used, then the output needs to be connected to the power factor corrector as well.

In the feedback loop, to prevent power from flowing in the reverse direction from the source to the DC-to-DC converter, a diode, for instance, may be inserted. In such a case, the output voltage of the DC-to-DC converter is V_{IN} plus the diode forward voltage. The diode is omitted in FIG. 16.

If the impedance of the load stays constant over time, and if the output voltage of the “rectifier and filter” is equal to V_{IN} when the diode is not inserted and if it is equal to the voltage the load requires, then the DC-to-DC converter can be omitted, and in that case, the feedback loop forms from the output of the “rectifier and filter” to the amplifier.

To start the PGTS, the switch is turned on momentarily to initiate the system. After power circulates through the feedback loop, the switch is turned off and the system continues to generate power.

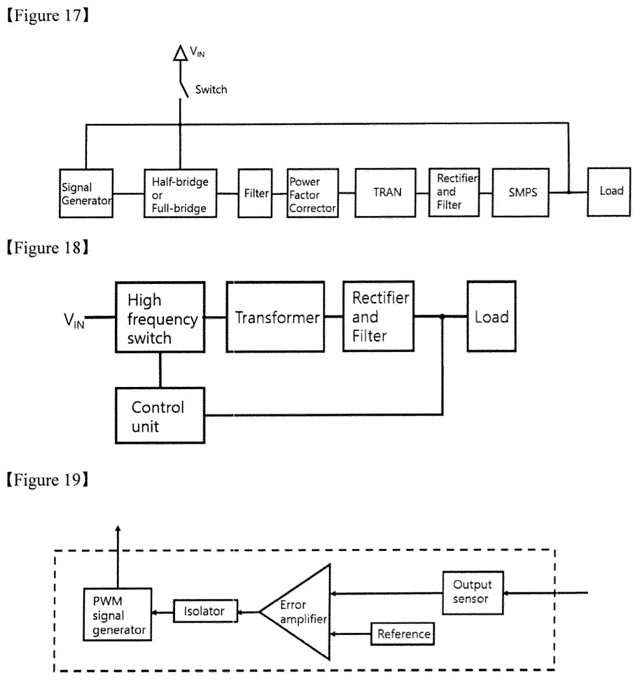

FIG. 17 shows an example of a block diagram of a PGTS with feedback with a half-bridge or a full-bridge as the amplifier and with an SMPS as the DC-to-DC converter.

FIG. 17 shows an example of a block diagram of a PGTS with feedback with a half-bridge or a full-bridge as the amplifier and with an SMPS as the DC-to-DC converter. The feedback loop forms from the output of the SMPS to the amplifier (a half-bridge or a full-bridge).

FIG. 18 shows a block diagram of an SMPS with a transformer.

FIG. 18 shows a block diagram of an SMPS with a transformer. In an SMPS, the voltage or the current in the circuit is monitored to regulate the output power. In the example of the SMPS in FIG. 18, the control unit monitors the output voltage of the “rectifier and filter” to generate the modulated control signal.

FIG. 19 shows a block diagram of a control unit of an SMPS using a pulse-width modulation (PWM).

In FIG. 19, a control unit of an SMPS using the pulse-width modulation (PWM) is shown. There are various ways of implementing the control unit. Another kind of modulation method, pulse-frequency modulation (PFM), for instance, can be used in the control unit. The output voltage is sensed by the output sensor and is compared with the reference voltage. Then the error is amplified by the error amplifier. Next, after the electric isolation, the input DC is changed to a chopped high frequency signal through the high frequency switch which is switched by the PWM signal generator. An optocoupler, for instance, is used for the isolator. The duty cycle of the PWM signal is controlled according to the changes in the impedance of the load so that the required power is transferred to the output.

### K. Simplified Block Diagrams of PGTS

Note that the control unit of the SMPS in FIG. 19 generates a high frequency signal just as the signal generator in FIG. 13 does. Also, the high frequency switch in FIG. 18 functions in the same way as the amplifier in FIG. 13 does. Therefore, the block diagram in FIG. 13 can be reduced to a simpler one when the modules with the same function are merged.

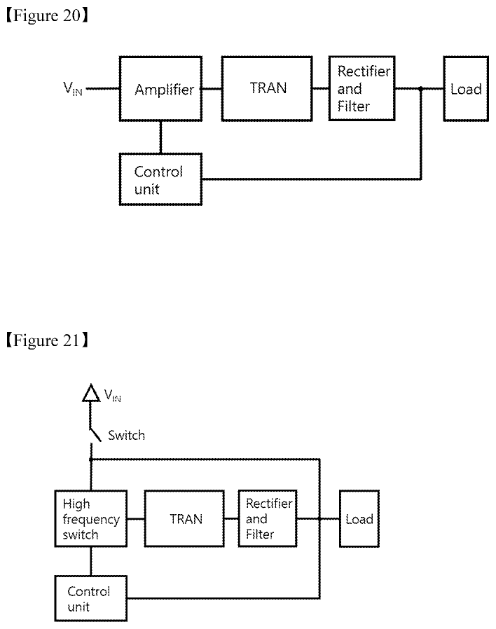

FIG. 20 shows a simplified block diagram of a PGTS without feedback.

FIG. 20 shows a simplified block diagram of a PGTS without feedback where the control unit of the SMPS is used as the signal generator generating a pulse train with varying duty cycles as the impedance of the load varies. The optional “filter” and the “power factor corrector” in FIG. 13 are omitted for the sake of simplicity in FIG. 20. Note that FIG. 20 illustrates a system with feedback from the output to the control unit, but this is classified as a system without feedback because the output power is not used to power the system through a feedback loop. Therefore, when the “filter” and the “power factor corrector” are removed, the block diagram of FIG. 13 can be reduced to a simplified block diagram in FIG. 20.

As already discussed, some machines that utilize a transformer can be converted into a PGTS. The principles of such conversion are already explained above with an example of an SMPS. Note that the simplified block diagram of a PGTS without feedback in FIG. 20 is the same as the block diagram of an SMPS that uses a transformer as shown in FIG. 18 if the TRAN in FIG. 20 is replaced by a transformer.

The amplifier used in the example of a block diagram is a half-bridge or a full-bridge in this invention. Note, however, that any type of SMPS utilizing a transformer can be converted into a PGTS. For instance, a forward converter can be modified to function as a PGTS if the transformer in the forward converter is replaced by a TRAN which enables the necessary phase change of the magnetic flux. (Mohammad Kamil, AN1114, Switch Mode Power Supply (SMPS) Topologies (Part I), Microchip Technology Inc., 2017.)

FIG. 21 shows a simplified block diagram of a PGTS without feedback that uses a half-bridge or a full-bridge amplifier.

FIG. 21 shows a simplified block diagram of a PGTS without feedback that uses a half-bridge or a full-bridge amplifier. In FIG. 21, the PWM signal generator generates the PWM pulses that switch the half-bridge or the full-bridge.

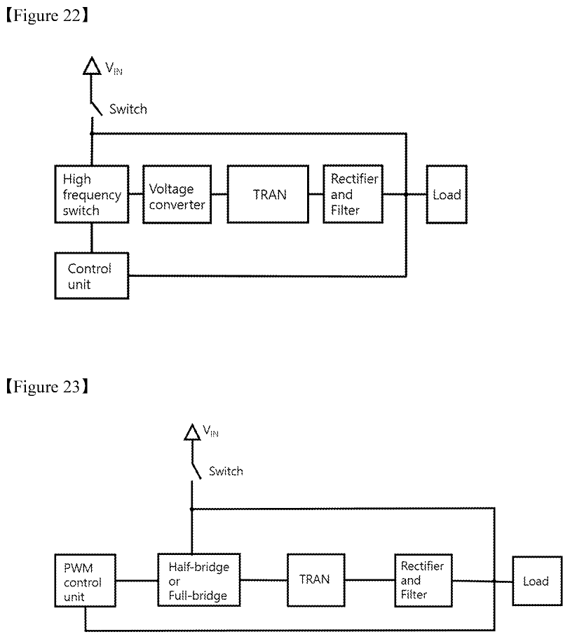

FIG. 22 shows a simplified block diagram of a PGTS with feedback.

FIG. 22 shows a simplified block diagram of a PGTS with feedback. When the “filter” and the “power factor corrector” are removed, the block diagram of FIG. 16 can be reduced to a simplified block diagram of FIG. 22. As the output of the “rectifier and filter” is fed back to the system, the output voltage should be the same as the input voltage V_{IN}. The output voltage can be adjusted by the numbers of turns of the coils of the TRAN. When the output voltage cannot reach V_{IN} by controlling the duty cycle of the PWM signal, a voltage converter might be necessary. The voltage converter is an AC-to-AC converter in this case when it is inserted before or right after TRAN. When the voltage is adjusted after the “rectifier and filter,” the voltage converter is a DC-to-DC converter.

FIG. 23 shows a simplified block diagram of a PGTS with feedback with a voltage converter.

FIG. 23 shows a simplified block diagram of a PGTS with feedback with a voltage converter. A transformer can be used as the voltage converter in this case. The transformer can be a usual transformer without having a long magnetic core, or can be a transformer like a TRAN having a long magnetic core. When a transformer with a long magnetic core is used as the voltage converter, not only the magnitude but also the phase of the impedance of the PGTS is affected by the phase change occurred in the transformer. As mentioned already, however, it is better to adjust the voltage by the numbers of turns of the coils of the TRAN.

FIG. 24 shows a simplified block diagram of a PGTS with feedback with a half-bridge or a full-bridge amplifier.

FIG. 24 shows a simplified block diagram of a PGTS with feedback with a half-bridge or a full-bridge amplifier. When the “filter” and the “power factor corrector” are removed, the block diagram of FIG. 17 can be reduced to a simplified block diagram of FIG. 24. The voltage converter is omitted by adjusting the voltage by the numbers of turns of the coils of the TRAN.

While the disclosure has been particularly shown and described with reference to embodiments thereof, it will be understood by one of ordinary skill in the art that various changes in form and details may be made therein without departing from the spirit and scope of the disclosure as defined by the appended claims. The embodiments should be considered in descriptive sense only and not for purposes of limitation. Therefore, the scope of the disclosure is defined not by the detailed description of the disclosure but by the appended claims, and all differences within the scope will be construed as being included in the disclosure.

1. A power generating transformer system (PGTS) comprising:
a transformer circuit (TC) comprising a transformer, a “rectifier and filter” module, and a load; and
an alternating current (AC) generator with right frequency (ACRF) configured to generate AC with frequency which lets a desired relative phase that is a difference between a phase of a flux at a primary coil and that of a flux at a secondary coil be in a specified range.

2. The PGTS of claim 1, wherein further comprising:
a power factor corrector configured to correct a power factor by controlling reactive power at the primary coil of the transformer of the TC or at a location where the AC is generated, by using one or more components in the TC.

3. The PGTS of claim 1, wherein the TC comprises a transformer whose magnetic core which is non-air has a closed loop or an open loop configuration, and the primary and the secondary coil of the transformer of the TC are wound at certain locations of the core.

4. The PGTS of claim 1, wherein the ACRF controls a value of the relative phase so that an impedance of the TC lies in an arbitrary quadrant of a complex plane of the impedance.

5. The PGTS of claim 2, wherein the power factor corrector controls the reactive power at the primary coil or at the location where the AC is generated so that a magnitude of the reactive power is minimized.

6. The PGTS of claim 1, wherein speed of the flux in the magnetic core depends on permeability or permittivity of a material of the magnetic core, and the relative phase is controlled by the speed of the flux and the frequency.

7. The PGTS of claim 1, wherein the core consisting of air and/or other material(s).

8. A method of correcting a power factor in a power generating transformer system (PGTS), the method comprising:
generating an alternating current (AC) with frequency which lets a desired relative phase that is a difference between a phase of a flux at a primary coil and that of a flux at a secondary coil of a transformer of the TC be in a specified range; and
correcting a power factor by controlling reactive power at the primary coil of the transformer of the TC or at a location where the AC is generated, by using one or more components in the TC.

9. The method of claim 8, wherein the TC comprises a core consisting of air and/or other material(s) where non-air part of the core has a closed loop or an open loop configuration, and the primary coil and the secondary coil of the transformer of the TC are wound at certain locations of the core.

10. The method of claim 8, further comprising controlling a value of the relative phase by adjusting the frequency of the AC generated by the ACRF so that an impedance of the TC lies in an arbitrary quadrant of a complex plane of the impedance.

11. The method of claim 8, wherein the correcting of the power factor comprises controlling the reactive power at the primary coil or at the location where the AC is generated so that a magnitude of the reactive power is minimized.

12. The method of claim 8, wherein speed of the flux in the magnetic core depends on permeability or permittivity of the material of the magnetic core, and the relative phase is controlled by the speed of the flux and the frequency.
